(19) United States
(12) Patent Application Publication
(10) Pub. No.: US 2010/0235599 A1
(43) Pub. Date: Sep. 16, 2010

(54) ACCESS CONTROL DEVICE, STORAGE SYSTEM, AND ACCESS CONTROL METHOD

(75) Inventors: Takamichi AKAGAWA, Kawasaki (JP); Akiko Jokura, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/720,296

(22) Filed: Mar. 9, 2010

(30) Foreign Application Priority Data
Mar. 12, 2009 (JP) 2009-060108

(51) Int. Cl. G06F 12/14; G06F 12/00

(52) U.S. Cl. 711/163; 711/154; 711/E12.001; 711/E12.093

(57) ABSTRACT

An access control device for controlling access from a host system to a plurality of storage areas in a storage system, the access control device includes a memory for storing access management information for the plurality of storage areas, and a controller for managing and monitoring access performed by the host system, the controller monitoring frequency of access by the host system to each of the plurality of storage areas and storing information of the frequency of the access to each of the storage areas in the memory, detecting at least one of the storage areas in which the frequency of the access is less than a predetermined range, and restricting the host system from accessing to the detected storage area.

### CROSS-REFERENCE TO RELATED APPLICATIONS

This application is based upon and claims the benefit of priority of the prior Japanese Patent Application No. 2009-60108, filed on Mar. 12, 2009, the entire contents of which are incorporated herein by reference.

### FIELD

The embodiments discussed herein are related to an access control device, a storage system, and an access control method.

### BACKGROUND

In recent years, a technology called IP-SAN (Internet Protocol-Storage Area Network) for connecting a storage system to a host computer using an Internet protocol has been developed. For example, in order to realize such a technology, the standard called iSCSI (Internet SCSI) has been developed. In iSCSI, the SCSI protocol is encapsulated into a TCP (transmission control protocol) packet and communication is performed.

In one of technologies using IP-SAN, information regarding logical unit numbers (LUNs) of storage systems accessible by a host computer is managed by an iSNS (Internet Storage Name Service) server. In such a technology, when a disk volume of a storage system is changed and, therefore, a LUN is generated or deleted, an iSNS server updates the disk configuration information, such as a LUN, in accordance with a change in configuration of the storage systems. Since a change in disk configuration information is centrally managed by the iSNS server, a host computer may acquire the latest disk configuration information from the iSNS server.

In addition, a method is disclosed in which in response to a logical volume allocation request from a host computer, a storage system allocates a logical volume to the host computer in accordance with a maximum usable disk capacity allocated to the host computer in advance. Since the disk capacity is automatically allocated to a host computer by a storage system, the disk capacity accessible by the host computer may be automatically set without user intervention. There are Japanese Laid-open Patent Publication Nos. 2005-332220 and 2008-84094 as reference documents.

In this technology, a logical volume is automatically allocated to a host computer by a storage system within the maximum disk capacity allowed for the host computer. However, the user needs to set the maximum disk capacity. Accordingly, if the user incorrectly sets the disk capacity accessible by the host computer, a logical unit that may not be accessed by the host computer or a logical unit that is never accessed by the host computer appears in the storage system, which is a problem.

### SUMMARY

According to an aspect of the embodiment, an access control device for controlling access from a host system to a plurality of storage areas in a storage system, the access control device includes a memory for storing access management information for the plurality of storage areas, and a controller for managing and monitoring access performed by the host system, the controller monitoring frequency of access by the host system to each of the plurality of storage areas and storing information of the frequency of the access to each of the storage areas in the memory, detecting at least one of the storage areas in which the frequency of the access is less than a predetermined range, and restricting the host system from accessing to the detected storage area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary hardware configuration of a storage computer including an access control device.

FIG. 2 illustrates an exemplary logical configuration of a memory.

FIG. 3 illustrates an example of access management information.

FIG. 4 illustrates an example of access management control information.

FIG. 5 illustrates an exemplary sequence of accessing data in the storage computer performed by the host computer.

FIG. 6 is a flowchart of an exemplary storage area allocation process.

FIG. 7 is a flowchart of an exemplary storage area examination process.

FIG. 8 is a flowchart of an exemplary process for monitoring access to a storage area and the process for restricting access to a storage area that has been accessed a number of times less than the minimum access count.

FIG. 9 illustrates the access management information set after access to the storage area that has been accessed a number of times less than the minimum access count is restricted.

FIG. 10 is a flowchart of an exemplary process for monitoring access to a storage area and restricting access to a storage area that has not been accessed for a period of time longer than the minimum access period of time.

FIG. 11 illustrates an exemplary hardware configuration of a storage computer including an access control device connected to a plurality of host computers.

FIG. 12 illustrates an exemplary sequence of accessing data in the storage computer performed by host computers.

FIG. 13 illustrates an example of access management information set when a storage area allocation process is performed for a host computer.

FIG. 14 illustrates access management information set after access to a storage area that has been accessed a number of times less than the minimum access count performed by a host computer is restricted and access to a storage area that has been accessed a number of times less than the minimum access count is restricted.

FIG. 15 illustrates an example of access management information set when a storage area allocation process is performed for a host computer.

FIG. 16 illustrates access management information set after an access restricted process is performed for a host computer.

FIG. 17 illustrates an exemplary hardware configuration of a switch including an access control device.

FIG. 18 illustrates an exemplary configuration of a memory.

FIG. 19A illustrates a sequence of accessing data in the storage computers performed by the host computers.

FIG. 19B is a continuation of the sequence of FIG. 19A.

FIG. 20 illustrates an example of the access management information set after the storage area allocation process is performed for a host computer.

FIG. 21 illustrates an example of the access management information set after the access restricted process is performed for a storage area that has been accessed a number of times smaller than the minimum access count.

FIG. 22 illustrates an example of the access management information set after the storage area allocation process is performed for another host computer.

FIG. 23 illustrates an example of the access management information set after access to a storage area that has been accessed a number of times smaller than the minimum access count performed by the host computer is restricted and access to a storage area having a non-access period longer than a minimum access period is restricted.

FIG. 24 illustrates an example of the access management information set after the storage area allocation process is performed for a host computer.

FIG. 25 illustrates an example of the access management information set after access to a storage area having a non-access period longer than a minimum access period performed by the host computer is restricted.

### DESCRIPTION OF EMBODIMENTS

Preferred embodiments of the present invention will be explained with reference to accompanying drawings. First and second embodiments of the access control device are described below with reference to the accompanying drawings.

### First Embodiment

In a first embodiment, a host computer is connected to a storage computer via an IP network. The access control device is incorporated in the storage computer. The access control device controls a storage area of a storage device to which access is permitted to the host computer.

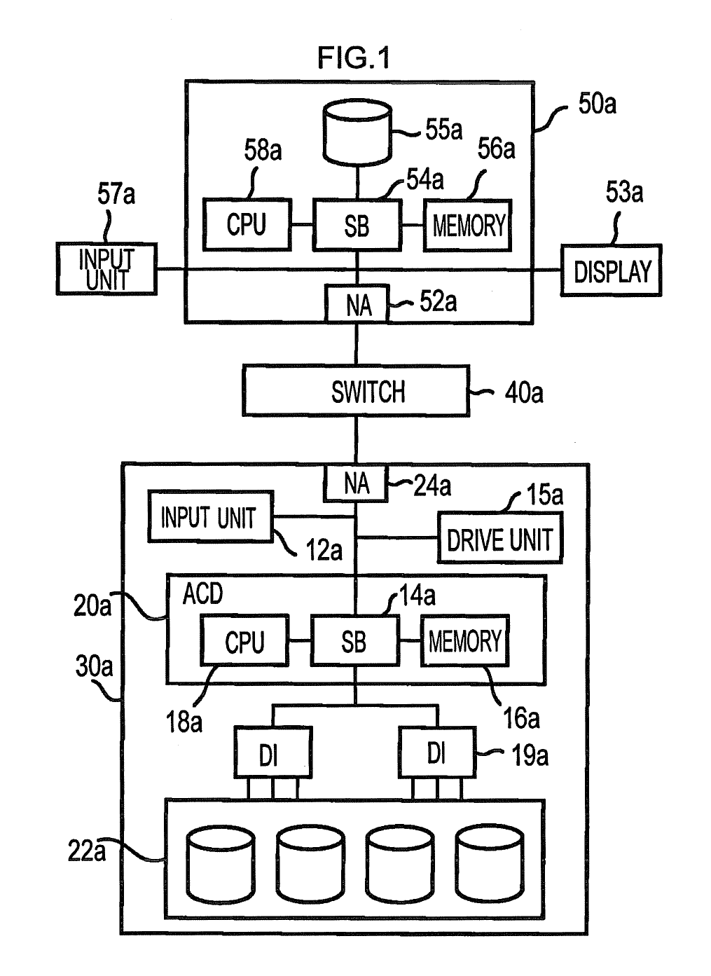

An exemplary hardware configuration of the storage computer including the access control device is described next with reference to FIG. 1. A storage computer 30a includes an input unit 12a, a drive unit 15a, a disk interface (DI) 19a, an access control device (ACD) 20a, a storage device 22a, and a network adaptor (NA) 24a. The access control device 20a includes a system bus (SB) 14a, a memory 16a, a central processing unit (CPU) 18a. The access control device 20a is connected to the storage device 22a via the disk interface 19a. A switch 40a is connected to the storage computer 30a and a host computer 50a via one of an IP network and a fiber channel network.

The components of the host computer 50a are described below. The host computer 50a includes a CPU 58a, a memory 56a, an input unit 57a, a display unit 53a, a system bus 54a, an external storage device 55a, and a network adaptor 52a.

The memory 56a includes a main memory and a flash memory. Examples of the main memory include a static random access memory (SRAM) and a dynamic random access memory (DRAM). Examples of the flash memory include an electrically erasable programmable ROM (EEPROM). One of a disk array of magnetic disks, a solid state drive (SSD) using a flash memory and an optical disk drive is used for the external storage device 55a.

The CPU 58a executes a program stored in the memory 56a. Thus, the CPU 58a communicates with the storage computer 30a using the iSCSI protocol and performs a function of reading and writing data from and to the storage device 22a.

An iSCSI name is input to the host computer 50a by a user of the storage computer 30a via the input unit 57a and is stored in the memory 56a so that the host computer 50a starts communication with the storage computer 30a using the iSCSI protocol.

The system bus 54a connects the CPU 58a, the memory 56a, the input unit 57a, the display unit 53a, the external storage device 55a, and the network adaptor 52a with one another. The system bus 54a is formed from an electronic circuit that operates in accordance with the standard of the AGP (Accelerated Graphics Port) or the PCI Express.

The network adaptor 52a is formed from an electronic circuit that performs communication complying with the standard of a particular physical layer and a data link layer of the Internet protocol or the fiber channel standard. When the network adaptor 52a employs the Internet protocol, a media access control (MAC) address is assigned to the network adaptor 52a for performing communication.

In contrast, when the network adaptor 52a performs communication via a fiber channel, the network adaptor 52a performs communication using a port address acquired from a name server provided in the switch 40a. In such a case, a world wide name (WWN) assigned to the network adaptor 52a is registered in the name server. Thus, a port address is distributed from the switch 40a to the host computer 50a and is stored in a memory 56a.

The components of the storage computer 30a are described below. The memory 16a includes a main memory and a flash memory. Examples of the main memory include an SRAM and a DRAM. Examples of the flash memory include an EEPROM.

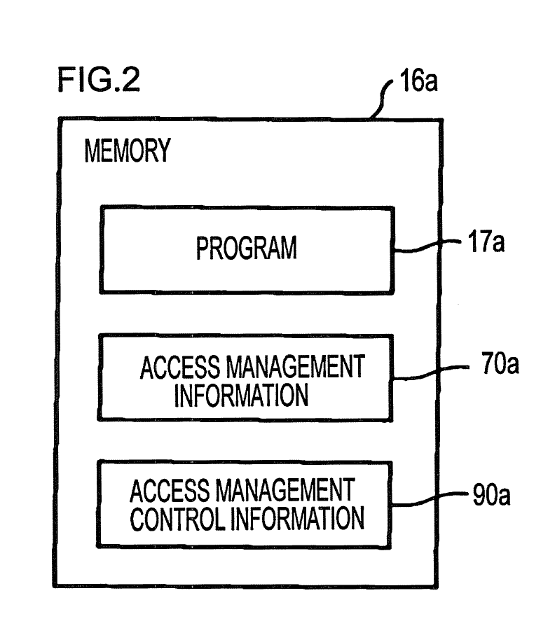

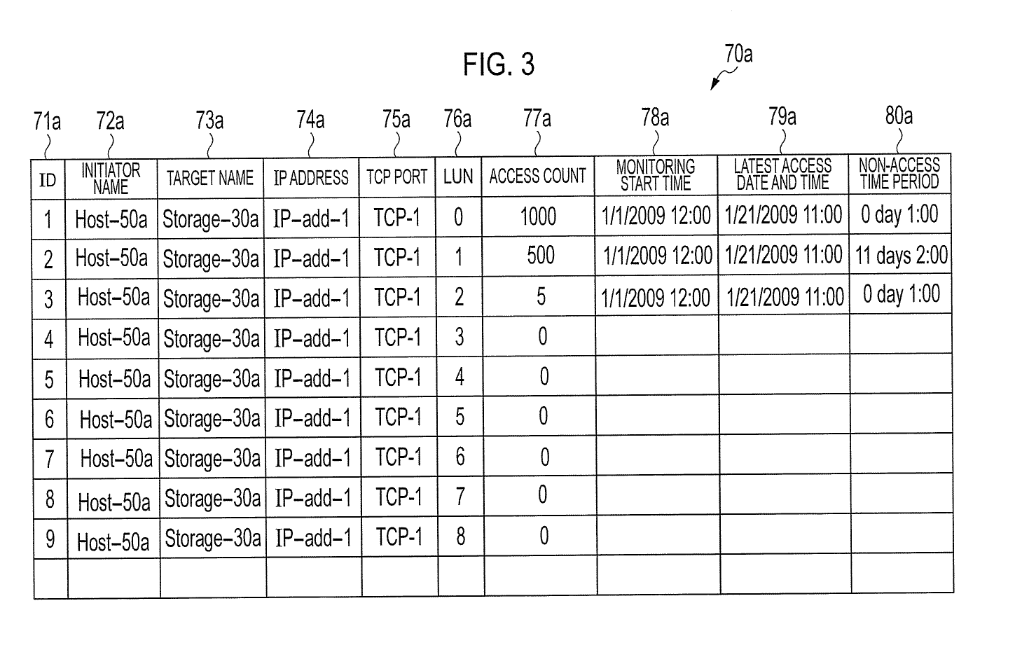

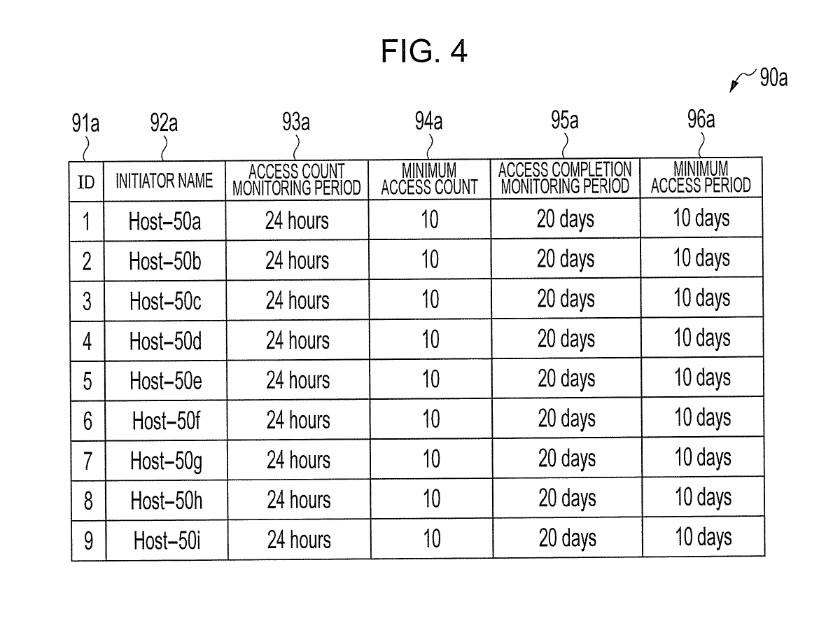

FIG. 2 illustrates an exemplary logical configuration of the memory 16a. As illustrated in FIG. 2, the memory 16a includes a program 17a, access management information 70a, and access management control information 90a. The access management information 70a is described in more detail below with reference to FIG. 3. The access management control information 90a is described in more detail below with reference to FIG. 4.

The user of the storage computer 30a may modify data contained in the access management information 70a and the access management control information 90a via the input unit 12a.

Referring back to FIG. 1, the drive unit 15a reads and writes data from and to a recording medium, such as a floppy (trade name) disk, a compact disc read only memory (CD-ROM), or a digital versatile disc (DVD). The drive unit 15a incorporates a motor that rotates a recording medium and a head that reads and writes data from and onto a surface of the recording medium. By mounting a recording medium containing the program 17a in the drive unit 15a, the program 17a is read by the drive unit 15a and is loaded into the memory 16a.

The input unit 12a includes a keyboard and a mouse used when the user inputs data or information to the CPU 18a.

The network adaptor 24a is formed from an electronic circuit that performs communication complying with the standard of a particular physical layer and a data link layer of the Internet protocol or the fiber channel standard. When the network adaptor 24a employs the Internet protocol, a MAC address is assigned to the network adaptor 24a for performing communication.

In contrast, when the network adaptor 24a performs communication via a fiber channel, the network adaptor 24a performs communication using a port address acquired from a name server provided by the switch 40a. In such a case, a world wide name (WWN) assigned to the network adaptor 24a is registered in the name server. Thus, a port address is distributed from the switch 40a to the storage computer 30a and is stored in the memory 16a.

Note that the network adaptor 24a receives the program 17a via a network. Thus, the program 17a may be stored in the memory 16a.

The disk interface 19a is an electronic circuit that connects the access control device 20a to the storage device 22a. Connection between the disk interface 19a and the storage device 22a is established using, for example, the FC-AL (Fibre Channel Arbitrated Loop) or SCSI.

The system bus 14a is a bus for connecting the CPU 18a, the memory 16a, the input unit 12a, the drive unit 15a, the disk interface 19a, and the network adaptor 24a with one another. The system bus 14a is formed from an electronic circuit that operates in accordance with the standard of the AGP or PCI Express.

The storage device 22a is formed from one of a disk array of magnetic disks, an SSD using a flash memory, and an optical disk drive.

The CPU 18a executes the program 17a stored in the memory 16a. The program 17a is stored in the form of object code defining an access management function, a disk management function, and a communication function, which are described in more detail below. Thus, the CPU 18a provides an access management function, a disk management function, and a communication function by executing the program 17a.

In addition, the program 17a may include a plurality of program components called modules or components. In such a case, the access management function, the disk management function, and the communication function are defined in the corresponding components. By executing one of the program components, the CPU 18a provides the function defined in the program component.

Hereinafter, the CPU 18a for providing the access management function by executing the program or the program component is referred to as an “access management unit”. In addition, the CPU 18a for providing the disk management function and the communication function by executing the program or the program component is referred to as an “access management unit” and “communication function unit”, respectively.

The disk management function includes redundant arrays of inexpensive disks (RAID) function and a function of changing the logical volume configuration information when a magnetic disk is added or removed.

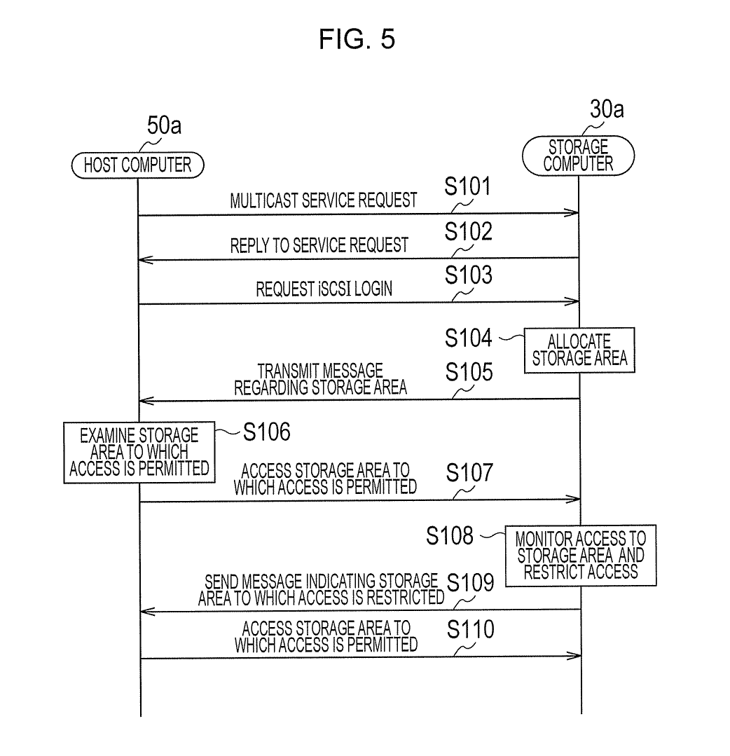

The communication function allows the storage computer 30a to communicate with the host computer using a communication protocol. When the communication function unit uses, for example, the iSCSI protocol as a communication protocol, the user of the storage computer 30a inputs the iSCSI name through the input unit 12a, and the iSCSI name is stored in the memory 16a. The communication function unit then establishes a session between the storage computer 30a and the host computer 50a using the iSCSI name. Data access between the communication function unit of the storage computer 30a and the host computer 50a is described in more detail below with reference to FIG. 5.

Through the access management function, if access of a host computer to the storage device is permitted and, subsequently, the host computer does not satisfy a predetermined access condition for accessing the storage area, the access of the host computer to the storage area is restricted.

An example of the predetermined access condition for accessing the storage area is frequency of accesses performed by a host computer, and concretely that the number of accesses performed by a host computer within a predetermined period of time is smaller than a predetermined number of accesses or that, after the above described predetermined period of time has elapsed, a storage area is found that has been never accessed by the host computer for a predetermined period of time that is longer than the above described predetermined period of time.

The storage area may be a logical unit. The logical unit is a unit of a logical volume used by the host computer. The logical unit is identified by a LUN. Allocation of a logical unit to the host computer 50a is recorded in access management information stored in the memory 56a.

If the access management information includes allocation of a storage area to a host computer (access permission), the access management function unit permits read access or write access to the storage area performed by the host computer. However, if the access management information includes no storage area allocation to a host computer, the access management function unit restricts read access or write access to the storage area performed by the host computer.

FIG. 3 illustrates an example of the access management information 70a. The access management function unit performs the access management function using the access management information 70a. A relationship between the access management information 70a and the process performed by the access management function unit is described below.

The access management information 70a is management information used when the CPU 18a performs the access management function. The access management information 70a includes an identification (ID) number field 71a, an initiator name field 72a, a target name field 73a, an IP address field 74a, and a TCP port field 75a. In addition, the access management information 70a includes a LUN field 76a, an access count field 77a, a monitoring start time field 78a, a latest access date and time field 79a, and a non-access time period field 80a. In the access management information 70a, data in each of the fields in a column corresponds to data in other fields in the row.

The identification number of a record is input into the identification number field 71a by the access management function unit. A name for identifying the iSCSI initiator is input into the initiator name field 72a by the access management function unit. For example, the abbreviated name “Host-50a” of the host computer 50a is input into the initiator name field 72a, as shown in FIG. 3.

The name for identifying the iSCSI target is input into the target name field 73a by the access management function unit. For example, the abbreviated name “Storage-30a” of the storage computer 30a is input into the target name field 73a. The name of an apparatus to be accessed by the apparatus identified by the initiator name field 72a is input into the target name field 73a.

The IP address of a storage computer identified by the target name field 73a and a TCP port usable through the iSCSI protocol are input into the IP address field 74a and the TCP port field 75a, respectively, by the access management function unit.

The LUN for identifying a logical unit allocated to the apparatus identified by the initiator name field 72a is input into the LUN field 76a by the access management function unit, so that the apparatus may access the logical unit. In FIG. 3, “0”, “1”, “2”, “3”, “4”, “5”, “6”, “7”, and “8” are set in the LUN fields 76a. These numbers indicate the LUNs of logical units of the storage computer 30a, to which access is permitted to the host computer 50a indicated by the initiator name field 72a.

The number of accesses to the logical units indicated by the LUNs performed by the host computer 50a in the initiator name field 72a is set in the access count field 77a by the access management function unit. Note that the type of access counted may be “write” or “read”. Immediately after the access management information 70a is generated, no data is written to a logical unit of the storage device 22a. Accordingly, the host computer 50a performs write access to the logical unit for which write access is granted.

The access management function unit acquires the initiator name from the iSCSI name field contained in the iSCSI message. In addition, the access management function unit analyzes the SCSI command encapsulated in the TCP packet of the iSCSI message and detects a LUN contained in the SCSI command. Thus, the access management function unit counts the number of actually performed accesses to the logical unit. In this way, the access management function unit determines whether write access or read access is performed to a predetermined logical unit and inputs the count number of accesses into the access count field 77a.

The point of time at which the access management information 70a is generated is input into the monitoring start time field 78a by the access management function unit.

The date and time at which the host computer 50a indicated by the initiator name field 72a most recently accessed the logical unit indicated by the LUN is set in the latest access date and time field 79a by the access management function unit.

The period of non-access time from the time point when the host computer 50a indicated by the initiator name field 72a most recently accessed the logical unit to the current time point is input into the non-access time period field 80a by the access management function unit.

By referring to the access management information 70a, the access management function unit controls access so that only a particular apparatus indicated by the initiator name field 72a is able to access the logical unit identified by the LUN field 76a of the unit indicated by the target name field 73a.

The access management function unit updates information in the access count field 77a, the latest access date and time field 79a, and the non-access time period field 80a in the access management information 70a using the number of write accesses and read accesses and the date and time of the latest access performed by the host computer 50a.

If the value in the access count field 77a is less than a predetermined value when the period of time in the non-access time period field 80a exceeds a predetermined period of time, the access management function unit deletes the apparatus name in the initiator name field 72a corresponding to the logical unit that has not been accessed.

The time points at which the access management function unit generates the access management information 70a and sends a message indicating an accessible LUN to the host computer 50a serving as an initiator are described below with reference to FIG. 5.

FIG. 4 illustrates an example of the access management control information 90a. The access management control information 90a contains a setting value used in a determination process performed by the access management function unit. A relationship between the access management control information 90a and the process performed by the access management function unit is described below.

The access management control information 90a is in the form of a table including an index field 91a, an initiator name field 92a, an access count monitoring period field 93a, a minimum access count field 94a, an access completion monitoring period field 95a, and a minimum access period field 96a. In the access management control information 90a, data in each of the fields in a column corresponds to data in other fields in the row.

An identification number of a record is input to the index field 91a by the access management function unit. The name for identifying an iSCSI initiator is input into the initiator name field 92a by the access management function unit. In FIG. 4, the abbreviated names “Host-50a” to “Host-50i” of the host computers 50a to 50i, respectively, are input into the initiator name field 92a.

A period of monitoring time for which the access management function unit performs an access restricted process in accordance with the number of accesses is set in the access count monitoring period field 93a.

The minimum access count serving as a threshold value used in a determination process performed by the access management function unit when the access management function unit deletes the apparatus name in the initiator name field 92a is input to the minimum access count field 94a by the access management function unit.

When a period of time set in the access count monitoring period field 93a has elapsed since the point of time set in the monitoring start time field 78a, the access management function unit determines whether a logical unit having a number of granted accesses less than the value in the minimum access count field 94a is present. If a logical unit having a number of granted accesses less than the value in the minimum access count field 94a is present, the access management function unit deletes the name of a host computer in the initiator name field 72a corresponding to the logical unit.

For example, when the value in the minimum access count field 94a is 10 and if the value in the access count field 77a is less than 10, the access management function unit deletes, from the initiator name field 72a, the name of the host computer that is allowed to access the logical unit and that has accessed the logical unit a number of times smaller than 10.

In this way, if the number of accesses to a storage area performed by a host computer within a predetermined period of time is smaller than a predetermined value after the access management function unit granted access to the storage area to the host computer, the access management function unit restricts access to the storage area performed by the host computer. Accordingly, the access control device may allocate the storage area that has not been accessed more than a predetermined times by some host computer to another host computer. Consequently, the access control device may automatically allocate a storage area of the storage device accessible by a host computer to one of host computers and use the allocated area in an optimal manner.

A period of time during which the access management function unit monitors accesses is input into the access completion monitoring period field 95a by the access management function unit. The period of time is used for the access management function unit to determine, using the value in the non-access time period field 80a, whether access to the logical unit performed by the host computer 50a is completed.

A period of time used when it is determined whether access to the logical unit performed by the host computer 50a is completed is input into the minimum access period field 96a.

After a period of time indicated by the access completion monitoring period field 95a has elapsed since the point of time indicated by the monitoring start time field 78a, the access management function unit determines whether the value in the non-access time period field 80a is greater than the value in the minimum access period field 96a. If the value in the non-access time period field 80a is greater than the value in the minimum access period field 96a, the access management function unit deallocates the logical unit allocated to the host computer that has never accessed the logical unit.

For example, as illustrated in FIG. 4, when “10days” is set in the minimum access period field 96a and if a non-access period longer than “10days” is set in the non-access time period field 80a, the permission to access such a logical unit is removed.

In this way, if a storage area which has never been accessed by the host computer for a minimum access period of time that is longer than the access count monitoring period of time is found after the access count monitoring period has elapsed, the access management function unit restricts access to the storage area performed by the host computer. Thus, the access management function unit may deallocate the storage area that has been allocated to the host computer that completed an access operation and allocate the storage area to a different host computer. Consequently, the access management function unit may automatically allocate a storage area of the storage device accessible by host computers to one of the host computers and use the allocated area in an optimal manner.

An exemplary sequence of accessing data in the storage computer 30a performed by the host computer 50a is described next with reference to FIG. 5.

In order to acquire the iSCSI name of an iSCSI target, the host computer 50a transmits a “Service Request” message including the iSCSI name of the host computer 50a using SLP (Service Location Protocol) by multicasting (step S101). Upon receipt of the “Service Request” message, the storage computer 30a transmits a reply message to the host computer 50a (step S102). The reply message for the “Service Request” message includes the iSCSI name, IP address, and TCP port of the storage computer 30a serving as the iSCSI target.

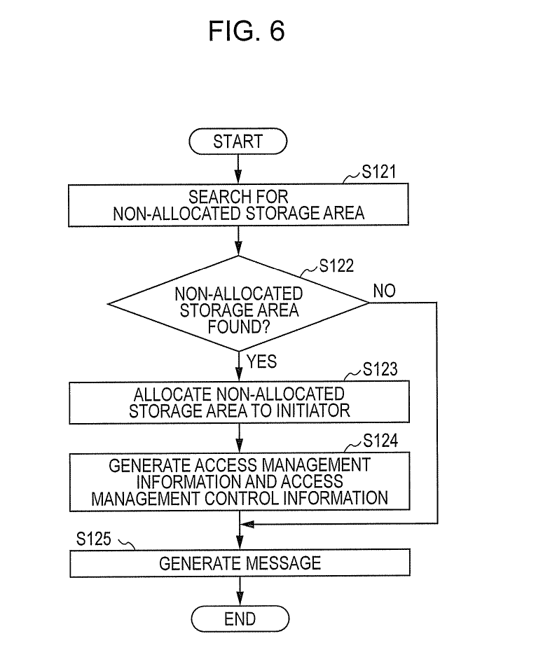

The host computer 50a transmits an iSCSI login request including the iSCSI name, IP address, and TCP port of the host computer 50a (step S103). Upon receipt of the login request from the host computer 50a, the storage computer 30a allocates a storage area accessible by the host computer 50a to the host computer 50a (step S104). The process for allocating a storage area is described in more detail below with reference to FIG. 6.

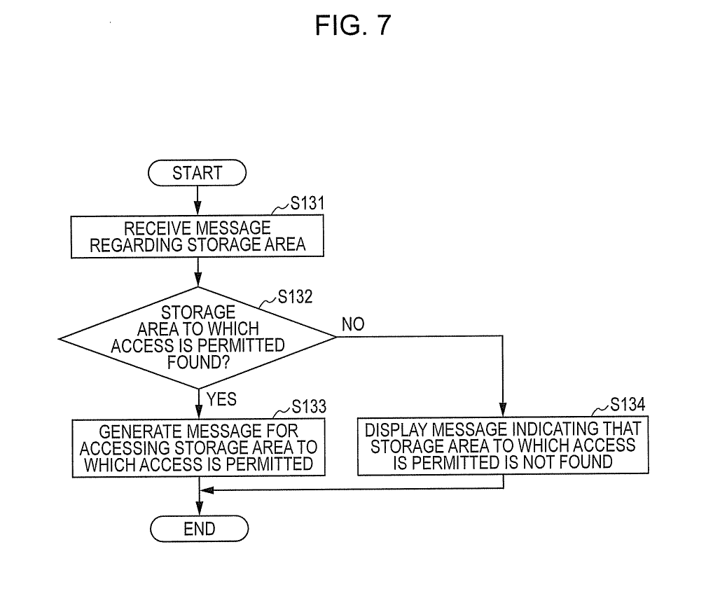

The storage computer 30a transmits a message regarding a storage area (step S105). The host computer 50a receives the message and examines the storage area allocated to the host computer 50a and accessible by the host computer 50a (step S106). The process for examining the allocated storage area is described in more detail below with reference to FIG. 7.

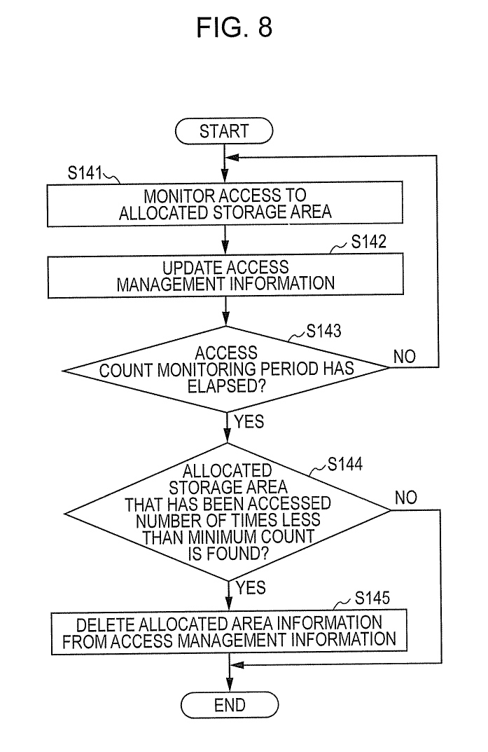

The host computer 50a accesses the accessible storage area (step S107). When the allocated area is accessed, the access management function unit monitors the storage area accessed by the host computer 50a. However, if the non-allocated storage area is accessed, the access management function unit restricts access to the storage area performed by the host computer 50a (step S108). The process performed by the access management function unit for monitoring and restricting access to a storage area is described in more detail below with reference to FIGS. 8 to 10.

When the access management function unit restricts the access to the storage area performed by the host computer 50a, the access management function unit sends, to the host computer 50a, a message indicating the storage area to which access is restricted (step S109). The host computer 50a accesses only the accessible storage area other than the storage area to which access is restricted (step S110).

In this way, the host computer 50a accesses data stored in the storage computer 30a.

A flowchart of an exemplary process for allocating a storage area is described next with reference to FIG. 6. In FIG. 6, the access management function unit allocates a storage area accessible by the host computer 50a to the host computer 50a and records that information in the access management information 70a. Thereafter, the access management function unit allows the host computer 50a to access the storage area using the access management information 70a.

In order to allocate a storage area that is accessible by the host computer 50a serving as an initiator, the access management function unit searches the storage device 22a for a storage area that is not allocated to any host computer (i.e., non-allocated storage area) (step S121). As used herein, the term “non-allocated storage area” refers to a storage area that is not allocated to any host computer as a storage area available for the host computer. For example, a logical unit formed from an additionally mounted physical disk serves as a non-allocated storage area.

Subsequently, the access management function unit determines whether a non-allocated storage area is present in the storage device 22a (step S122). If a non-allocated storage area is present in the storage device 22a (“Yes” in step S122), the access management function unit allocates the non-allocated storage area to the host computer 50a serving as the initiator (step S123).

Note that the host computer 50a may access the storage device 22a of the storage computer 30a for the first time. Alternatively, after the host computer 50a previously accessed the storage computer 30a, the host computer 50a may request allocation of a storage area again. In step S122, by referring to the access management information 70a, the access management function unit does not consider the storage area that has been allocated to the host computer 50a or another host computer to the host computer 50a as a non-allocated storage area and, therefore, does not allocate the storage area to the host computer 50a.

If a non-allocated storage area is not present (“No” in step S122), the access management function unit performs a message generating process as described below (step S125).

Using the host computer 50a as an initiator name, the access management function unit generates the access management information 70a indicating that an accessible storage area is allocated to the host computer 50a (step S124). The information regarding the time point when the access management information 70a is generated is input into the monitoring start time field 78a. In addition, predetermined values are set in the other fields of the access management information 70a and the access management control information 90a. When a storage area is allocated, the access management function unit generates a message regarding the allocated and accessible storage area (step S125). However, when a non-allocated area is not present (“No” step S122) and, therefore, a storage area is not allocated, the access management function unit generates a message indicating that no accessible areas are found (step S125). Note that the elapsed time set in the access count monitoring period field 93a may be contained in the generated message for other host computers. If an access restricted process described below is performed after the period of time in the access count monitoring period field 93a has elapsed, an allocatable storage area may be generated. Accordingly, in order for the host computer 50a to request allocation of the newly generated storage area after the period of time set in the access count monitoring period field 93a has elapsed, data access may be resumed from step S101 again.

A flowchart of an exemplary process for examining an allocated storage area is described next with reference to FIG. 7.

The host computer 50a receives the message regarding a storage area from the storage computer 30a (step S131). The CPU 58a analyzes the received message and determines whether an accessible storage area is present (step S132). If an accessible storage area is present (“Yes” in step S132), the CPU 58a generates a message used for accessing the accessible storage area (step S133). When the host computer 50a uses the iSCSI protocol, the CPU 58a generates a message including a TCP packet that encapsulates a SCSI command. However, if an accessible storage area is not present (“No” in step S132), a message indicating that the storage area is allocated to another computer is displayed on the display unit 53a. In addition, the elapsed time set in the access count monitoring period field 93a is displayed (step S134).

Since the elapsed time set in the access count monitoring period field 93a is displayed in this manner, the user may know when the host computer 50a executes the process starting from step S101 illustrated in FIG. 5 again and accesses the storage computer 30a.

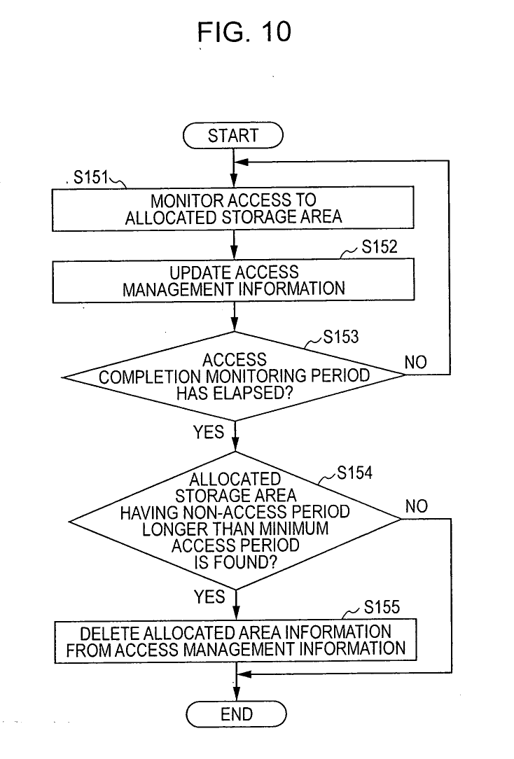

The process for monitoring access to a storage area and the process for restricting access to a storage area performed by the storage computer 30a in step S108 illustrated in FIG. 5 are described below with reference to FIGS. 8 to 10. In FIG. 8, the access management function unit performs the process for monitoring access to a storage area and the process for restricting access to a storage area that has been accessed a number of times less than the minimum access count. In FIG. 10, the access management function unit performs the process for monitoring access to a storage area and the process for restricting access to a storage area having a non-access period of time longer than the minimum access period of time.

A flowchart of an exemplary process for monitoring access to a storage area and the process for restricting access to a storage area that has been accessed a number of times less than the minimum access count is described with reference to FIG. 8.

The access management function unit monitors access to a storage area allocated to and accessible by the host computer 50a performed by the host computer 50a (step S141). The access management function unit analyzes a SCSI command encapsulated in a TCP packet of the iSCSI message transmitted from the host computer 50a and detects the LUN contained in the SCSI command. Thus, the access management function unit detects access to the storage area. Thereafter, the access management function unit updates the access management information 70a in accordance with the detected access to the storage area (step S142). By analyzing the SCSI command and detecting the LUN contained in the SCSI command, the access management function unit updates the values stored in the access count field 77a, the latest access date and time field 79a, and the non-access time period field 80a.

The access management function unit recognizes the value “24hours” stored in the access count monitoring period field 93a of the access management control information 90a and determines whether the period of time indicated by the access count monitoring period field 93a has elapsed since the time point indicated by the monitoring start time field 78a (step S143). If the access count monitoring period has not yet elapsed (“No” in step S143), the access management function unit continues to monitor access to the storage area allocated to the host computer 50a (step S141). However, if the access count monitoring period has elapsed (“Yes” in step S143), the access management function unit determines whether the value in the access count field 77a is smaller than the value in the minimum access count field 94a (step S144). If an allocated area having the value in the access count field 77a that is smaller than the value in the minimum access count field 94a is present (“Yes” in step S144), the access management function unit deletes, from the access management information 70a, the information regarding the allocated area having the value in the access count field 77a that is smaller than the value in the minimum access count field 94a (step S145). However, if an allocated area having the value in the access count field 77a that is smaller than the value in the minimum access count field 94a is not present (“No” in step S144), the access management function unit completes the processing without performing the processing in step S145.

As a result of the process for restricting access to the storage area that has been accessed a number of times less than the minimum access count illustrated in FIG. 8 (i.e., the processing performed in steps S144 and S145), the value stored in the access count field 77a for a logical unit having “2” in the LUN field 76a shown in FIG. 3 is set to “5”. Since the value in the minimum access count field 94a of the access management control information 90a is “10”, the access management function unit deallocates the logical unit having a LUN of “2” allocated to the host computer 50a and deletes the information from the access management information 70a. In the example of the access management information 70a illustrated in FIG. 3, the access management function unit deletes the value “host-50a” in the initiator name field 72a for a record having the value “2” in the LUN field 76a.

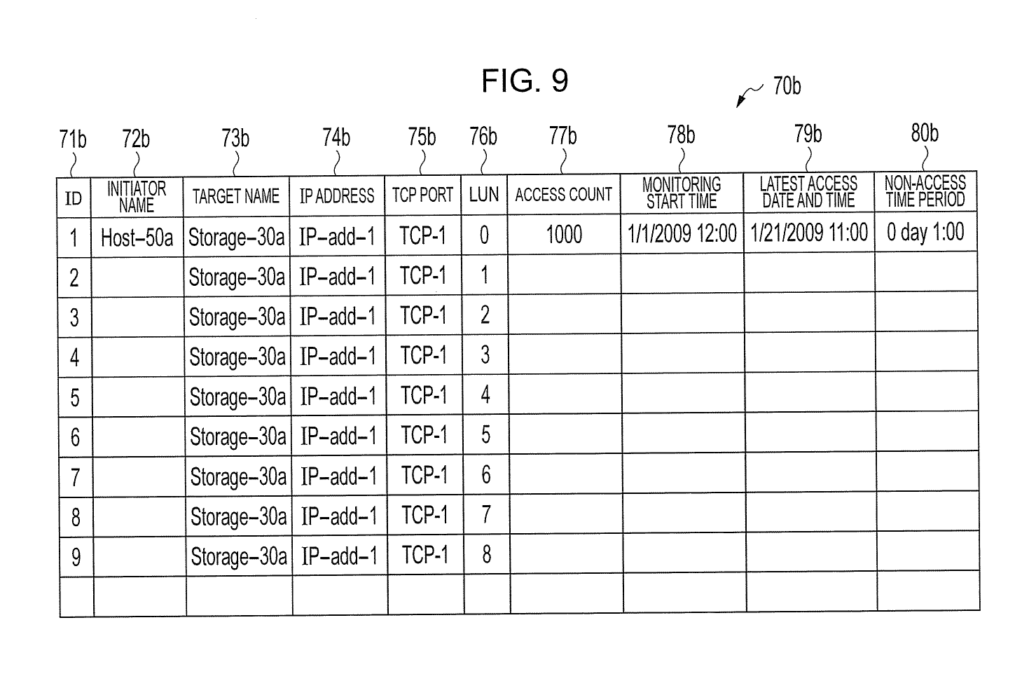

The access management information set after the access to the storage area that has been accessed a number of times less than the minimum access count is restricted is described next with reference to FIG. 9. The access management information 70a illustrated in FIG. 3 is modified into access management information 70b through the access restricted process.

An identification number field 71b, an initiator name field 72b, a target name field 73b, an IP address field 74b, and a TCP port field 75b correspond to the identification number field 71a, the initiator name field 72a, the target name field 73a, the IP address field 74a, and the TCP port field 75a illustrated in FIG. 3, respectively. In addition, a LUN field 76b, an access count field 77b, a monitoring start time field 78b, a latest access date and time field 79b, and a non-access time period field 80b correspond to the LUN field 76a, the access count field 77a, the monitoring start time field 78a, the latest access date and time field 79a, and the non-access time period field 80a illustrated in FIG. 3, respectively.

As a result of the process for restricting access to the storage area that has been accessed a number of times less than the minimum access count illustrated in FIG. 8 (i.e., the processing performed in steps S144 and S145), allocation of a logical unit having “2” in the LUN field 76b to the host computer 50a is terminated.

In addition, in the records having “3” to “8” in the LUN fields 76a shown in FIG. 3, the values in the access count field 77a are “0”s. Accordingly, as indicated by the records having “3” to “8” in the LUN fields 76b, the information regarding allocation of the logical units having “3” to “8” in the LUN fields 76b to the host computer 50a is deleted from the access management information 70b.

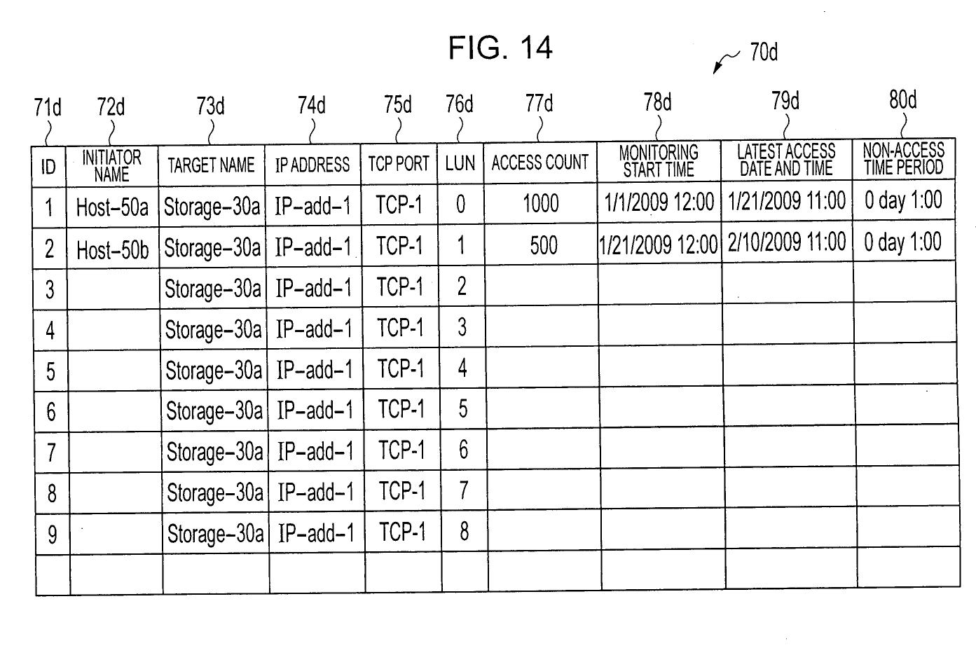

In this way, after the access management function unit allows the host computer to access the storage area, if the number of accesses performed by the host computer within a predetermined period of time is less than a predetermined number of accesses, the access management function unit restricts access to the storage area performed by the host computer. Accordingly, the access management function unit may deallocate the storage area that has not been accessed a number of times less than the predetermined number of times by one of the host computers and allocate the storage area to another host computer, as described below with reference to FIG. 14. Consequently, the access management function unit may automatically allocate a storage area of the storage device accessible by host computers to one of the host computers and use the allocated area in an optimal manner.

A flowchart of an exemplary process for monitoring access to a storage area and restricting access to a storage area that has not been accessed for a period of time longer than the minimum access period of time performed by the access management function unit is described next with reference to FIG. 10.

The access management function unit monitors access to a storage area allocated to the host computer 50a performed by the host computer 50a (step S151). The access management function unit updates the access management information 70a in accordance with accesses to the storage area (step S152). Since the processes performed in steps S151 and S152 are similar to those performed in steps S141 and S142, respectively, descriptions of the processes performed in steps S151 and S152 are not repeated.

The access management function unit detects the value “20days” set in the access completion monitoring period field 95a of a record having the value “Host-50a” in the initiator name field 92a. Thereafter, the access management function unit determines whether the period of time indicated by the access completion monitoring period field 95a has elapsed since the time point indicated by the monitoring start time field 78a (step S153). If the period of time indicated by the access completion monitoring period field 95a has not yet elapsed since the time point indicated by the monitoring start time field 78a (“No” in step S153), the access management function unit continues monitoring accesses to the allocated storage area (step S151). However, if the period of time indicated by the access completion monitoring period field 95a has elapsed since the time point indicated by the monitoring start time field 78a (“Yes” in step S153), the access management function unit determines whether a storage area having a value in the non-access time period field 80a greater than the value in the minimum access period field 96a is present (step S154). If a storage area having a value in the non-access time period field 80a greater than the value in the minimum access period field 96a is present (“Yes” in step S154), the access management function unit terminates the allocation of the storage area to the host computer 50a (step S155) and completes its processing. However, if a storage area having a value in the non-access time period field 80a greater than the value in the minimum access period field 96a is not present (“No” in step S154), the access management function unit completes its processing without terminating the allocation (step S155).

The access management information set after access to a storage area that has not been accessed for a period of time longer than the minimum access period of time is restricted is described next with reference to FIG. 10. The access management information 70a illustrated in FIG. 3 is modified into the access management information 70b through the access restricted process.

The non-access time period field 80a of a record having the value “1” in the LUN field 76a contains “11days 2:00”. In contrast, the minimum access period field 96a of the access management control information 90a illustrated in FIG. 4 contains “10days”. Accordingly, through the process for restricting access to a storage area that has not been accessed for a period of time longer than the minimum access period of time illustrated in FIG. 10 (steps S154 and S155), allocation of the logical unit having a LUN of “1” to the host computer 50a in the access management information 70b is terminated.

In this way, if a storage area that has not been accessed for the minimum access period of time longer than the access count monitoring period of time is present after the access count monitoring period of time has elapsed, the access management function unit restricts access to the storage area performed by the host computer. Accordingly, the access management function unit may deallocate a storage area that has not been accessed a number of times less than the predetermined number of times by one of the host computers and allocate the storage area to another host computer. Consequently, the access management function unit may deallocate the storage area that has been allocated to a host computer and that is not accessed by the host computer and allocate the storage area to another host computer and use the allocated area in an optimal manner.

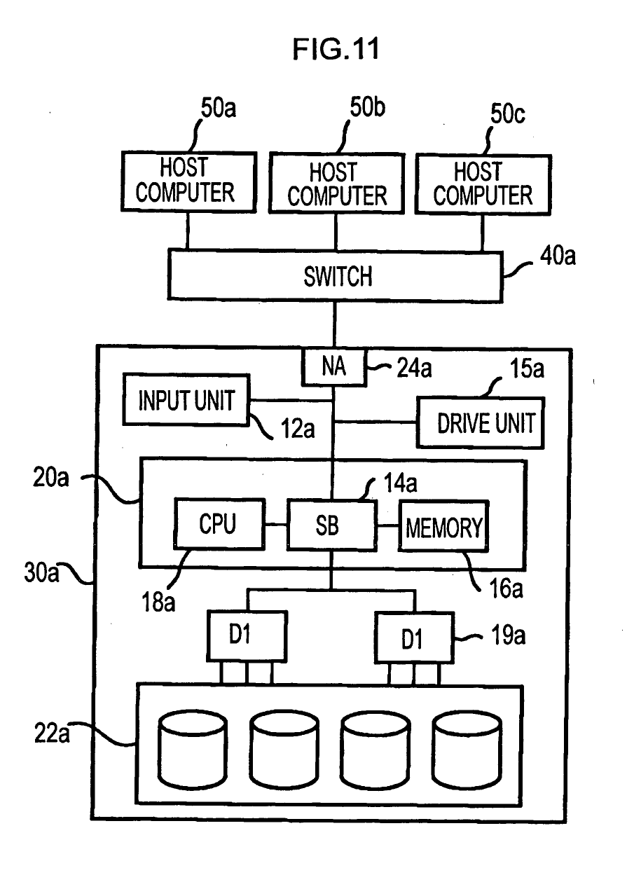

FIG. 11 illustrates an exemplary hardware configuration of a storage computer including an access control device connected to a plurality of host computers. As illustrated in FIG. 11, host computers 50b and 50c are connected to the switch 40a in addition to the host computer 50a illustrated in FIG. 1. Each of the host computers 50b and 50c has hardware components similar to those of the host computer 50a. Since the hardware configuration of each of the host computers 50b and 50c is similar to that of the host computer 50a illustrated in FIG. 1, the description thereof is not repeated.

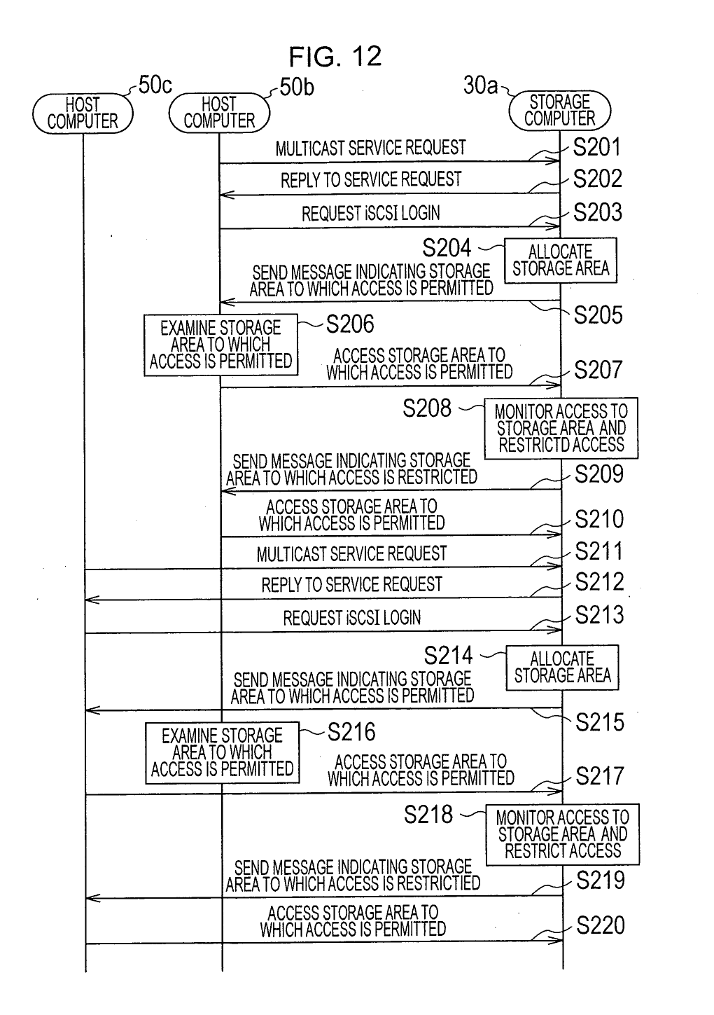

Exemplary sequences of accessing data in the storage computer 30a performed by the host computers 50b and 50c are described next with reference to FIG. 12. Note that this sequence is executed after the sequence illustrated in FIG. 5 is executed.

An exemplary sequence of accessing data in the storage computer 30a performed by the host computer 50b is described first.

The processing performed in steps S201 to S210 illustrated in FIG. 12 is similar to that performed in steps S101 to S110 illustrated in FIG. 5 except that the host computer 50a is replaced with the host computer 50b. However, the access management information is updated in accordance with the process for monitoring access and the process for restricting access to the storage area for the host computer 50b. Accordingly, the access management information updated in steps S204 and S208 is described below.

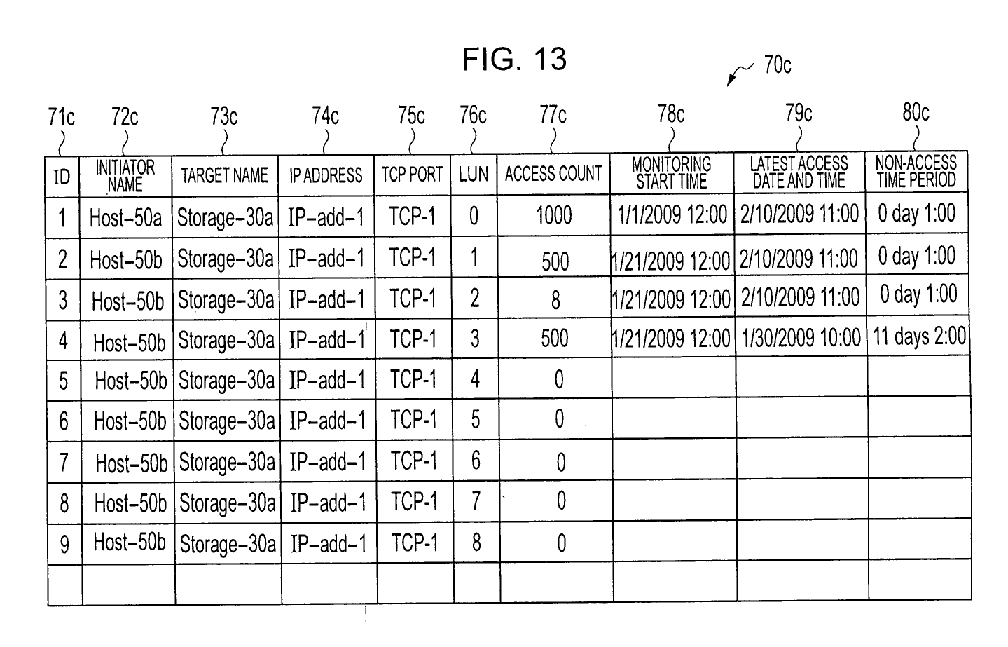

FIG. 13 illustrates an example of access management information 70c set when a storage area allocation process is performed for the host computer 50b. The access management information 70b illustrated in FIG. 9 is modified into the access management information 70c through the storage area allocation process.

An identification number field 71c, an initiator name field 72c, a target name field 73c, an IP address field 74c, and a TCP port field 75c correspond to the identification number field 71b, the initiator name field 72b, the target name field 73b, the IP address field 74b, and the TCP port field 75b illustrated in FIG. 9, respectively. In addition, a LUN field 76c, an access count field 77c, a monitoring start time field 78c, a latest access date and time field 79c, and a non-access time period field 80c correspond to the LUN field 76b, the access count field 77b, the monitoring start time field 78b, the latest access date and time field 79b, and the non-access time period field 80b illustrated in FIG. 9, respectively.

As illustrated in FIG. 13, access to the logical units having “1” to “8” in the LUN fields 76b illustrated in FIG. 9 is permitted to the host computer 50b indicated by the initiator name fields 72c.

In step S208, if the allocated storage area is accessed, the access management function unit monitors the storage area accessed by the host computer 50b. However, if a non-allocated storage area is accessed by the host computer 50b, the access management function unit restricts the access to the non-allocated storage area performed by the host computer 50b. In step S208, the access management function unit monitors access to storage areas having “2” to “8” in the LUN fields 76c performed by the host computer 50b. The access management function unit then updates the values in the access count field 77c, the monitoring start time field 78c, the latest access date and time field 79c, and the non-access time period field 80c.

Access management information 70d set after access to a storage area that has been accessed a number of times less than the minimum access count performed by the host computer 50b is restricted and access to a storage area having a non-access period of time longer than the minimum access period of time is restricted is described next with reference to FIG. 14. The access management information 70c illustrated in FIG. 13 is modified into the access management information 70d illustrated in FIG. 14 through the access restricted process.

An identification number field 71d, an initiator name field 72d, a target name field 73d, an IP address field 74d, and a TCP port field 75d correspond to the identification number field 71c, the initiator name field 72c, the target name field 73c, the IP address field 74c, and the TCP port field 75c illustrated in FIG. 13, respectively. In addition, a LUN field 76d, an access count field 77d, a monitoring start time field 78d, a latest access date and time field 79d, and a non-access time period field 80d correspond to the LUN field 76c, the access count field 77c, the monitoring start time field 78c, the latest access date and time field 79c, and the non-access time period field 80c illustrated in FIG. 13, respectively.

As illustrated in FIG. 13, the value in the access count field 77c for each of the logical units having “2” and “4” to “8” in the LUN fields 76c is smaller than “10” contained in the minimum access count field 94a. Accordingly, through the access restricted process illustrated in FIG. 8 in which access to a storage area that has been accessed a number of times less than the minimum access count is restricted (i.e., the processing performed in steps S144 and S145), the names of the host computers that are allowed to access the logical units having “2” and “4” to “8” in the LUN fields 76c are deleted, as illustrated in FIG. 14.

As illustrated in FIG. 13, a value in the non-access time period field 80c of the record having “3” in the LUN field 76c is greater than “10 days” set in the minimum access period field 96a. Accordingly, through the access restricted process illustrated in FIG. 10 in which access to a storage area having a non-access period of time longer than the minimum access period of time is inhibited (i.e., the processing performed in steps S151 and S152), the names of the host computers that are allowed to access the logical unit having “3” in the LUN fields 76d are deleted, as illustrated in FIG. 14.

Referring back to FIG. 12, access to data stored in the storage computer 30a is performed by the host computer 50c after the sequence of accessing data stored in the storage computer 30a performed by the host computer 50b is completed.

The processing performed in steps S211 to S220 illustrated in FIG. 12 is similar to that performed in steps S101 to S110 illustrated in FIG. 5 except that the host computer 50a is replaced with the host computer 50c. Accordingly, the description thereof is not repeated. However, the access management information is updated in accordance with the process for monitoring access and the process for restricting access to the storage area for the host computer 50c. Accordingly, the access management information updated in steps S214 and S218 is described below.

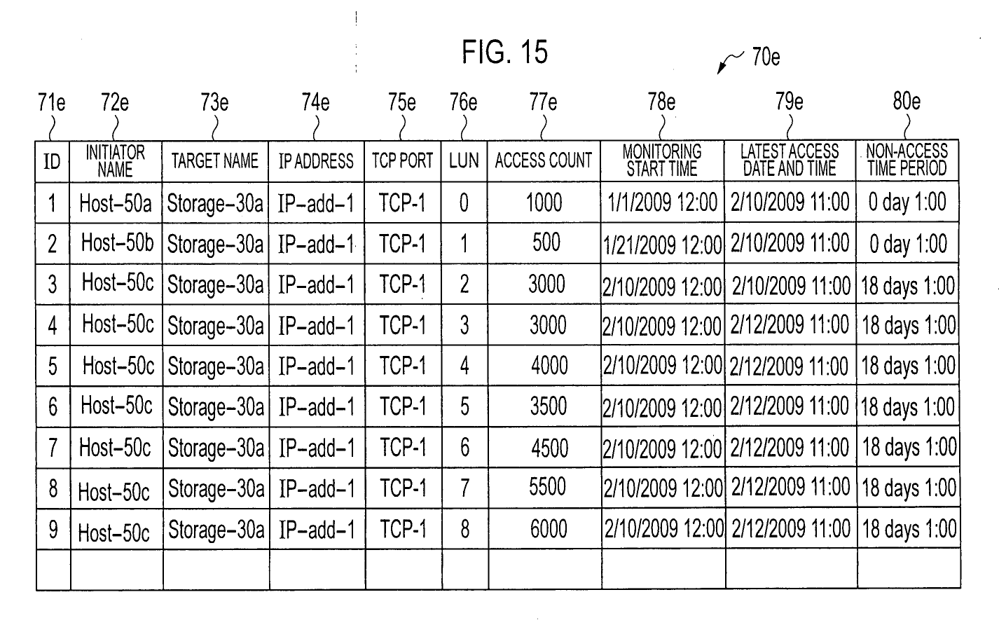

FIG. 15 illustrates an example of access management information 70e set when a storage area allocation process is performed for the host computer 50c.

An identification number field 71e, an initiator name field 72e, a target name field 73e, an IP address field 74e, and a TCP port field 75e correspond to the identification number field 71d, the initiator name field 72d, the target name field 73d, the IP address field 74d, and the TCP port field 75d illustrated in FIG. 14, respectively. In addition, a LUN field 76e, an access count field 77e, a monitoring start time field 78e, a latest access date and time field 79e, and a non-access time period field 80e correspond to the LUN field 76d, the access count field 77d, the monitoring start time field 78d, the latest access date and time field 79d, and the non-access time period field 80d illustrated in FIG. 9, respectively.

Since, as illustrated in FIG. 14, the logical units having “2” to “8” in the LUN fields 76d are not allocated to any host computers, the logical units having “2” to “8” in the LUN fields 76e are allocated to the host computer 50c so that the host computer 50c may access the logical units, as illustrated in FIG. 15.

In step S218, if the allocated storage area is accessed, the access management function unit monitors the storage area accessed by the host computer 50c. However, if a non-allocated storage area is accessed by the host computer 50c, the access management function unit restricts the access to the storage area. In step S218, the access management function unit monitors access to the storage areas having “2” to “8” in the LUN fields 76e performed by the host computer 50c. The access management function unit then updates the values in the access count field 77e, the monitoring start time field 78e, the latest access date and time field 79e, and the non-access time period field 80e.

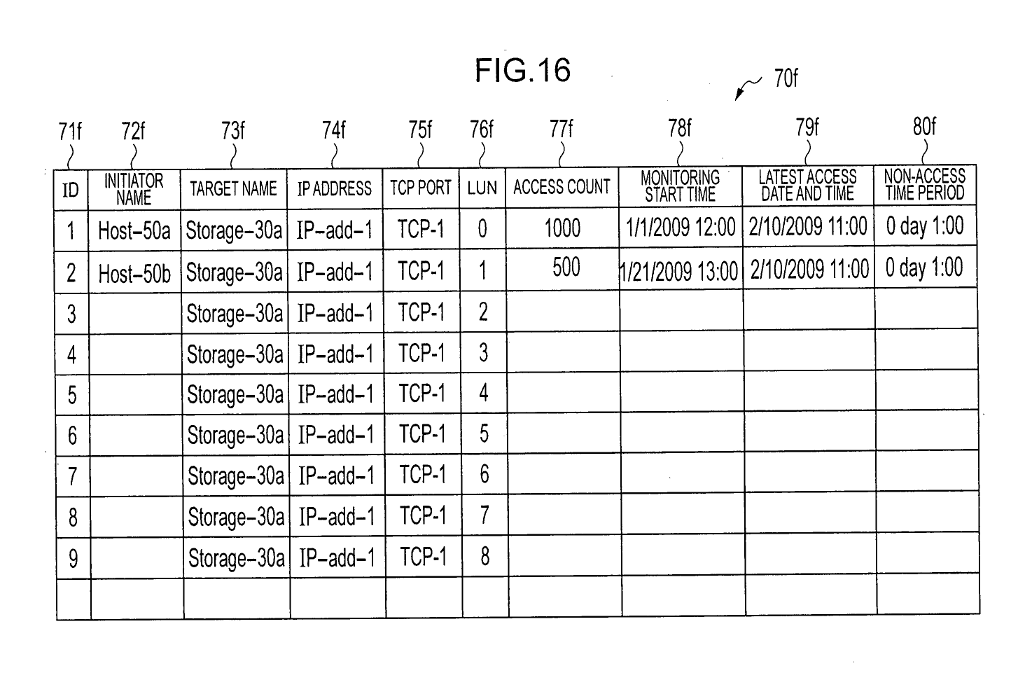

Access management information 70f set after access to a storage area that has been accessed a number of times less than the minimum access count by the host computer 50c is restricted and access to a storage area having a non-access period of time longer than the minimum access period of time is restricted is described next with reference to FIG. 16. The access management information 70e illustrated in FIG. 15 is modified into the access management information 70f illustrated in FIG. 16 through the above described access restricted process.

As illustrated in FIG. 15, the value in the access count field 77e for each of the logical units having “2” to “8” in the LUN fields 76e is greater than “10” contained in the minimum access count field 94a. Accordingly, through the access restricted process illustrated in FIG. 8 in which access to a storage area that has been accessed a number of times less than the minimum access count is restricted (i.e., the processing performed in steps S144 and S145), the names of the host computers that are allowed to access the logical unit having “2” to “8” in the LUN fields 76e are not deleted.

As illustrated in FIG. 15, the value in the non-access time period fields 80e of each of the records having “2” to “8” in the LUN fields 76e is greater than “10 days” set in the minimum access period field 96a. Accordingly, through the access restricted process illustrated in FIG. 10 in which access to a storage area having a non-access period of time longer than the minimum access period of time is restricted (i.e., the processing performed in steps S151 and S152), the name of the host computer that are allowed to access the logical units having “2” to “8” in the LUN fields 76f are deleted, as illustrated in FIG. 16.

In this way, if a storage area which has not been accessed by a host computer for a minimum access period of time that is longer than the access count monitoring period of time is found after the access count monitoring period has elapsed, the access management function unit restricts access to the storage area performed by the host computer. Thus, the access management function unit may deallocate the storage area that has been allocated to a computer that completed access and allocate the deallocated storage area to another computer. Consequently, the access management function unit may automatically allocate a storage area of the storage device accessible by host computers to one of the host computers and use the allocated area in an optimal manner.

### Second Embodiment

The difference between the first embodiment and the second embodiment is that, in the first embodiment, the access control device 20a is included in the storage computer 30a, while, in the second embodiment, an access control device 20b is included in a switch 40b. In the second embodiment, accesses to the storage device performed by a host computer are managed by the access control device 20b included in the switch 40b.

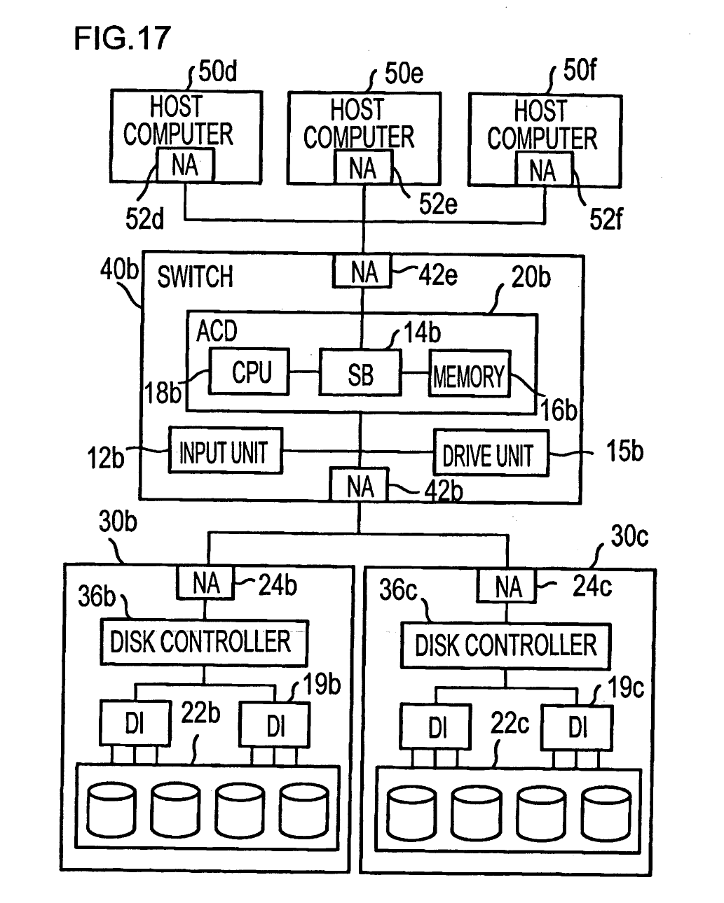

An exemplary hardware configuration of a switch including an access control device is described next with reference to FIG. 17.

The switch 40b includes network adaptors 42a and 42b, the access control device 20b, an input unit 12b, and a drive unit 15b. The switch 40b is connected to storage computers 30b and 30c and host computers 50d, 50e, and 50f via an IP network or a fibre channel network.

The access control device 20b is disposed in the switch 40b. The access control device 20b includes a system bus 14b, a memory 16b, and a CPU 18b. These components of the switch 40b are described below.

Hereinafter, the switch 40b, the host computers 50d, 50e, and 50f, and the storage computers 30b and 30c are sequentially described.

The memory 16b includes a main memory and a flash memory. Examples of the main memory include an SRAM and a DRAM. Examples of the flash memory include an EEPROM.

FIG. 17 illustrates an exemplary logical configuration of the memory 16b. As illustrated in FIG. 17, the memory 16b stores a program 17b, access management information 70g, and access management control information 90a. Since the access management information 70g has a data structure that is the same as that of the access management information 70a illustrated in FIG. 3, the descriptions of the fields of the access management information 70g are not repeated. In addition, since the access management control information 90a is the same as the access management control information 90a illustrated in FIG. 4, the description thereof is not repeated.

Each of the network adaptors 42a and 42b is formed from an electronic circuit that performs communication complying with the standard of a particular physical layer and a data link layer of the Internet protocol or the fiber channel standard.

In order for the network adaptors 42a and 42b to communicate with the host computers 50d to 50f and the storage computers 30b and 30c using the iSCSI protocol, an iSCSI name is input by a user via the input unit 12b and is stored in the memory 16b.

Discovery of the iSCSI name may be performed by using SLP. The iSCSI name of the initiator may be input into a “Service Request”, and the “Service. Request” may be transmitted by multicasting.

The drive unit 15b reads and writes data from and to a recording medium, such as a floppy (trade name) disk, a CD-ROM, or a DVD. The drive unit 15b incorporates a motor that rotates a recording medium and a head that reads and writes data from and onto a surface of the recording medium. By mounting a recording medium containing the program 17b in the drive unit 15b, the program 17b is read by the drive unit 15b and is loaded into the memory 16b.

The input unit 12b includes a keyboard and a mouse used when the user inputs data or information to the CPU 18b. The user may modify the data contained in the access management information 70g and the access management control information 90a by using the input unit 12b.

The system bus 14b is a bus for connecting the CPU 18b, the memory 16b, the input unit 12b, the drive unit 15b, and the network adaptors 42a and 42b with one another. The system bus 14b is formed from an electronic circuit that operates in accordance with the standard of the AGP or PCI Express.

The CPU 18b executes the program 17b stored in the memory 16b. The program 17b defines an access management function and a communication function, which are described in more detail below. Thus, the CPU 18b provides the access management function and the communication function by executing the program 17b.

In addition, the program 17b may include a plurality of program components called modules or components. In such a case, the access management function and the communication function are defined in the corresponding components. By executing one of the program components, the CPU 18b provides the function defined in the program component.

Hereinafter, the CPU 18b for providing the access management function by executing the program or the program component is referred to as an “access management unit”. In addition, the CPU 18b for providing the communication function by executing the program or the program component is referred to as a “communication function unit”.

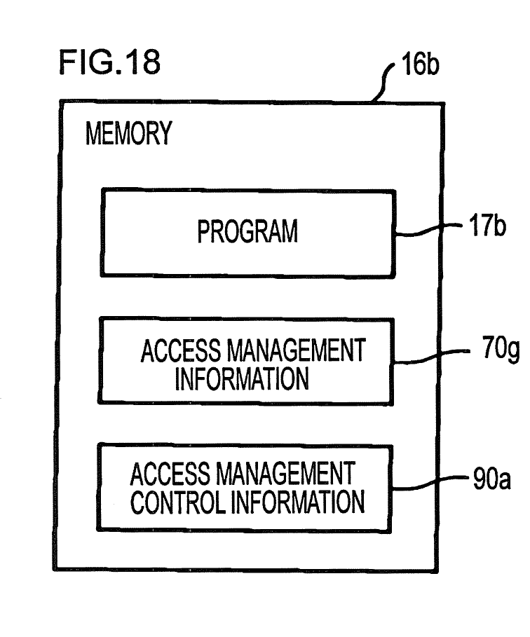

The communication function allows the switch 40b to communicate with a host computer and a storage computer using a communication protocol. When the communication function unit uses, for example, the iSCSI protocol as a communication protocol, the user of the switch 40b inputs the iSCSI name through the input unit 12b, and the iSCSI name is stored in the memory 16b. The communication function unit then establishes a session between the switch 40b and each of the host computers 50d to 50f using the iSCSI name. Data exchange between the communication function unit of the switch 40b and each of the host computers 50d to 50f is described in more detail below with reference to FIG. 18.

The access management function of the CPU 18b is similar to the access management function illustrated in FIG. 1 except that the storage computer 30a having a storage area is replaced with the storage computers 30b and 30c.

The access management function unit analyzes an SCSI command encapsulated in the TCP packet of the iSCSI message transmitted from a host computer and detects a LUN contained in the SCSI command. In this way, by referring to the access management information, the access management function unit determines whether the logical unit of the storage computer 30b or 30c corresponding to the detected LUN is allocated to the host computer that sent the iSCSI message and permits or restricts access to the logical unit performed by the host computer. Note that allocation of the logical units of the storage computer 30b or 30c to the host computers 50d to 50f is recorded in the access management information 70g, which is described in more detail below.

Each of the storage computers 30b and 30c has components that are the same as those of the storage computer 30a except that the access control device 20a is replaced with a disk controller. Accordingly, the descriptions of the components that are the same as those of the storage computers 30b and 30c are not repeated, and only the disk controller is described.

Disk controllers 36b and 36c include a RAID control function and a disk management function of updating the configuration information on a logical volume in accordance with addition and deletion of a magnetic disk.

The hardware configuration of each of the host computers 50d to 50f is the same as that of the host computer 50a shown in FIG. 1. Accordingly, the description thereof is not repeated.

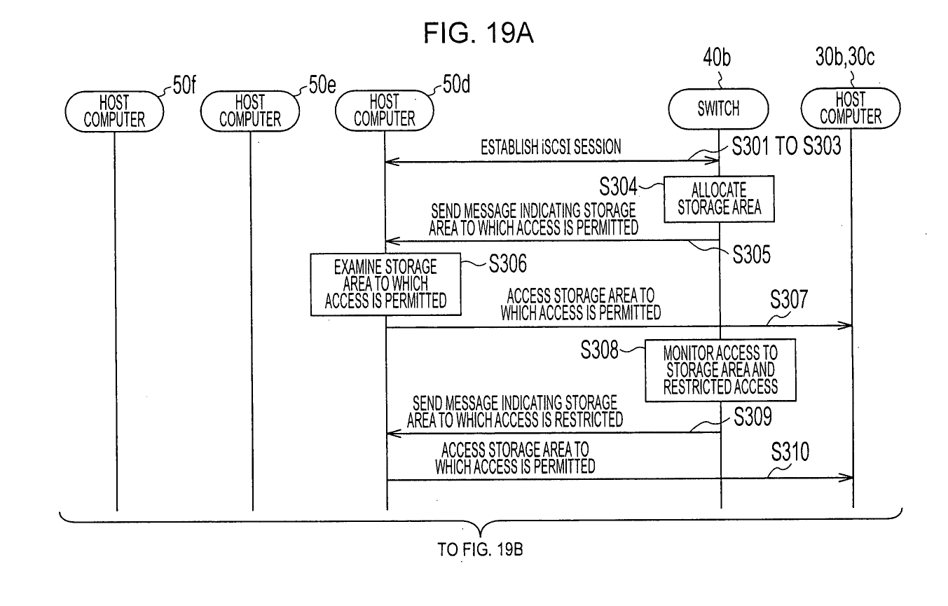

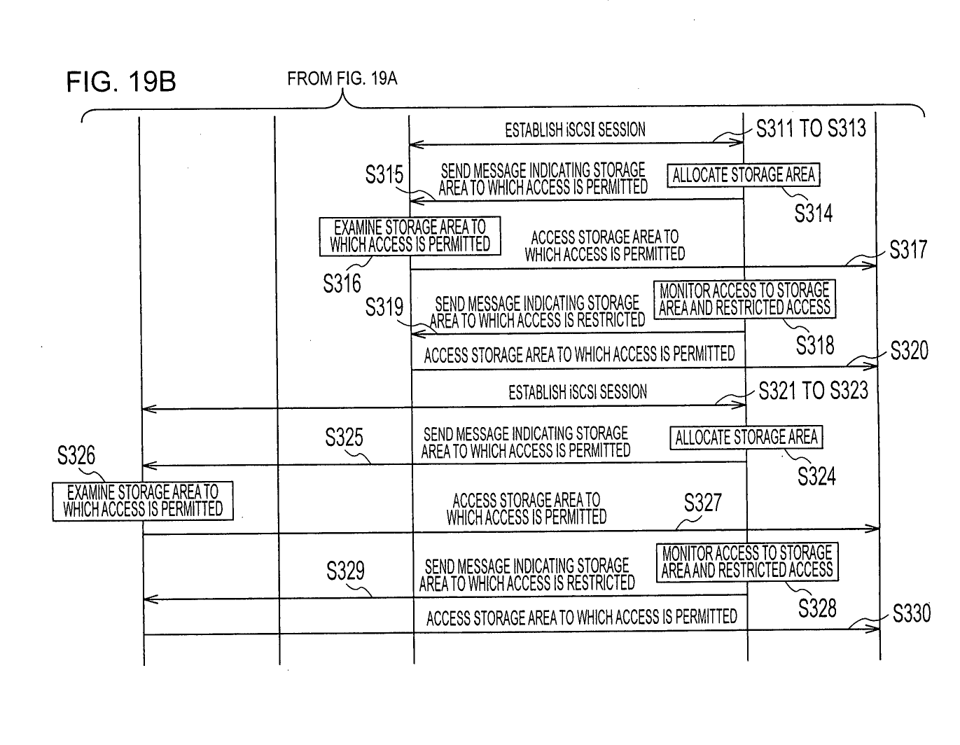

An exemplary sequence of data access to the storage computers 30b and 30c performed by the host computers 50d to 50f is described below with reference to FIGS. 19A and 19B.

An exemplary sequence of data access to the storage computer 30b or 30c performed by the host computer 50d is described next. In steps S301 to S303, the processing that is the same as that performed in steps S101 to S103 illustrated in FIG. 5 is performed except that the host computer 50a is replaced with the host computer 50d and the storage computer 30a accessed by the host computer is replaced with the switch 40b. Accordingly, the descriptions of steps S301 to S303 are not repeated.

In step S304, the storage area allocation process illustrated in FIG. 6 is performed. In the storage area allocation process (step S304), the access management function unit allocates a storage area to the host computer 50d so that the host computer 50d may access the storage area. The access management function unit records that allocation in the access management information 70g. Subsequently, the access management function unit allows the host computer 50d to access the storage area by referring to the access management information 70g.

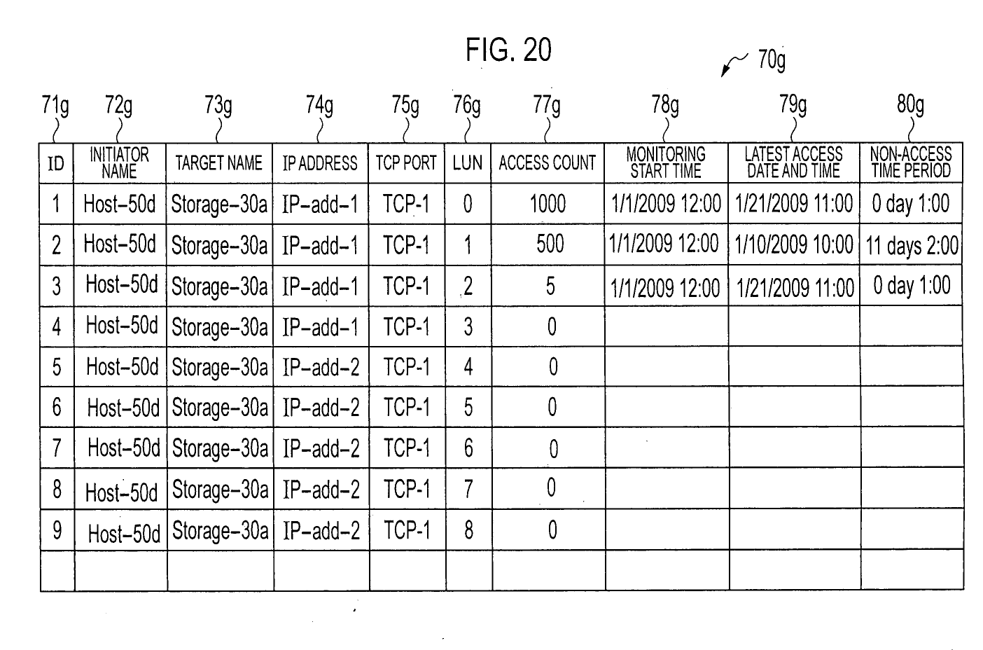

FIG. 20 illustrates an example of the access management information 70g set after the storage area allocation process is performed for the host computer 50d.

An identification number field 71g, an initiator name field 72g, a target name field 73g, an IP address field 74g, and a TCP port field 75g correspond to the identification number field 71a, the initiator name field 72a, the target name field 73a, the IP address field 74a, and the TCP port field 75a illustrated in FIG. 3, respectively. In addition, a LUN field 76g, an access count field 77g, a monitoring start time field 78g, a latest access date and time field 79g, and a non-access time period field 80g correspond to the LUN field 76a, the access count field 77a, the monitoring start time field 78a, the latest access date and time field 79a, and the non-access time period field 80a illustrated in FIG. 3, respectively.

As illustrated in FIG. 20, the logical units having “0” to “8” in the LUN fields 76g are allocated to and accessible by the host computer 50d. As indicated by the target name field 73g, the logical units having LUNs of 0 to 3 are included in the storage computer 30b, and the logical units having LUNs of 4 to 8 are included in the storage computer 30c.

Referring back to FIG. 19A, the switch 40b transmits a message regarding the storage area (step S305). The host computer 50d receives the message and examines the allocated storage area to which access is permitted (step S306). In step S306, the process for examining a storage area to which access is permitted is performed, as illustrated in FIG. 7.

The host computer 50d accesses the storage area to which access is permitted (step S307). The access management function unit examines that the iSCSI name transmitted from the host computer 50d is contained in the target name field 73g and permits the host computer 50d to access the storage computer 30b or 30c. When access is permitted, the access management function unit transfers the iSCSI message received from the host computer 50d or a SCSI command extracted from the iSCSI message to the storage computer 30b or 30c. In this way, the switch 40b transmits a SCSI command to the storage computer 30b or 30c and, therefore, data access to the logical unit indicated by the LUN may be performed by the host computer 50d.

If, in step S308, the allocated area is accessed, the access management function unit monitors the storage area accessed by the host computer 50d. However, if a non-allocated area is accessed, the access management function unit restricts the access. In step S308, the access management function unit performs a monitoring process and an access restricted process, as illustrated in FIG. 8.

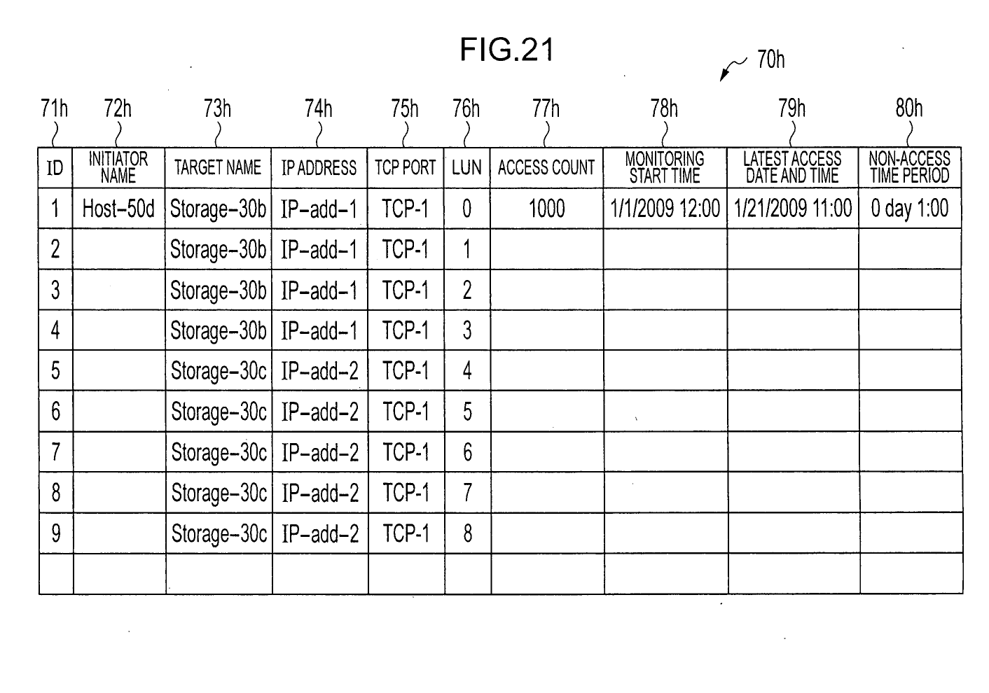

Access management information 70h set after the access restricted process is performed in step S308 using the number of accesses is described next with reference to FIG. 21. The access management information 70g illustrated in FIG. 20 is changed into the access management information 70h through the access restricted process.

An identification number field 71h, an initiator name field 72h, a target name field 73h, an IP address field 74h, and a TCP port field 75h correspond to the identification number field 71g, the initiator name field 72g, the target name field 73g, the IP address field 74g, and the TCP port field 75g illustrated in FIG. 20, respectively. In addition, a LUN field 76h, an access count field 77h, a monitoring start time field 78h, a latest access date and time field 79h, and a non-access time period field 80h correspond to the LUN field 76g, the access count field 77g, the monitoring start time field 78g, the latest access date and time field 79g, and the non-access time period field 80g illustrated in FIG. 20, respectively.

As a result of the access restricted process using the number of accesses illustrated in FIG. 8 (steps S144 and S145), the value in the access count field 77h representing the number of accesses to the logical unit having “2” in the LUN field 76h is “5”. Since the value in the minimum access count field 94a of the access management control information 90a is 10, the information regarding allocation of the logical unit having a LUN of 2 to the host computer 50d is deleted from the access management information 70h.

In addition, the values in the access count fields 77e for the logical units having “3” to “8” in the LUN fields 76h are “0”s. Accordingly, the information regarding allocation of the host computer 50d to the logical units having “3” to “8” in the LUN fields 76h is deleted from the access management information 70h.

As a result of the access restricted process using the non-access period of time illustrated in FIG. 10 (steps S151 and S152), the value in the non-access time period field 80h for the record having “1” in the LUN field 76h is “11day 2:00”. The value in the minimum access period field 96a of the access management control information 90a illustrated in FIG. 4 is “10days”. Accordingly, as illustrated in FIG. 21, the information regarding allocation of the logical units having a LUN of “1” to the host computer 50d is deleted from the access management information 70h.

The processing performed in steps S309 to S310 is similar to that performed in steps S109 to S110 illustrated in FIG. 5 except that the host computer 50a is replaced with the host computer 50d and the storage computer 30a accessed by the host computer is replaced with the switch 40b. Accordingly, the descriptions of steps S309 to S310 are not repeated.

An exemplary sequence of data access to the storage computers 30b or 30c performed by the host computer 50e is described next.

The processing performed in steps S311 to S313 is similar to that performed in steps S101 to S103 illustrated in FIG. 5 except that the host computer 50a is replaced with the host computer 50e and the storage computer 30a accessed by the host computer is replaced with the switch 40b. Accordingly, the descriptions of steps S311 to S313 are not repeated.

In step S314, the storage area allocation process illustrated in FIG. 6 is performed. In the storage area allocation process (step S314), the access management function unit allocates a storage area to the host computer 50e so that the host computer 50e may access the storage area. The access management function unit records that allocation in the access management information 70h. Subsequently, the access management function unit allows the host computer 50e to access the storage area by referring to the access management information 70h.

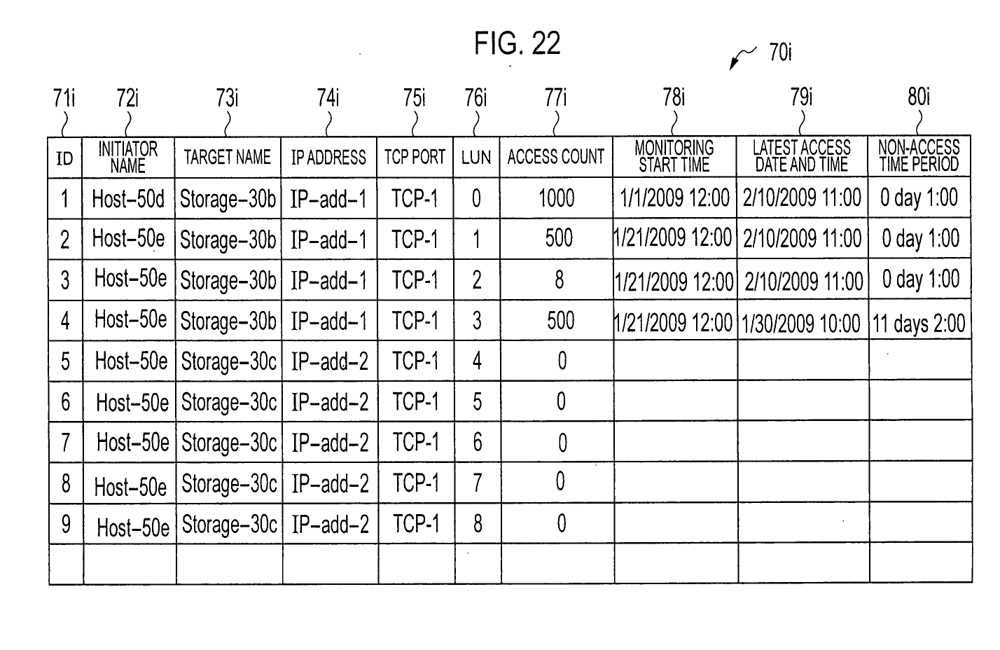

An example of access management information 70i set after the storage area allocation process is performed for the host computer 50e is described next with reference to FIG. 22. The access management information 70h illustrated in FIG. 21 is changed into the access management information 70i through the storage area allocation process.

An identification number field 71i, an initiator name field 72i, a target name field 73i, an IP address field 74i, and a TCP port field 75i correspond to the identification number field 71h, the initiator name field 72h, the target name field 73h, the IP address field 74h, and the TCP port field 75h illustrated in FIG. 21, respectively. In addition, a LUN field 76i, an access count field 77i, a monitoring start time field 78i, a latest access date and time field 79i, and a non-access time period field 80i correspond to the LUN field 76h, the access count field 77h, the monitoring start time field 78h, the latest access date and time field 79h, and the non-access time period field 80h illustrated in FIG. 21, respectively.

As illustrated in FIG. 22, the logical units having “1” to “8” in the LUN fields 76i illustrated in FIG. 21 are allocated to the host computer 50e so that the host computer 50e may access the allocated logical units.

Referring back to FIG. 19B, the switch 40b transmits a message regarding the storage area (step S315). The host computer 50e receives the message and examines the allocated storage area to which access is permitted (step S316). In step S316, the process for examining a storage area to which access is permitted is performed, as illustrated in FIG. 7.

The host computer 50e accesses the storage area to which access is permitted (step S317). The access management function unit examines that the iSCSI name transmitted from the host computer 50e is contained in the target name field 73i and permits the host computer 50e to access the storage computer 30b or 30c. When access is permitted, the access management function unit transfers the iSCSI message received from the host computer 50e or a SCSI command extracted from the iSCSI message to the storage computer 30b or 30c.

If, in step S318, the allocated area is accessed, the access management function unit monitors the storage area accessed by the host computer 50e. However, if a non-allocated area is accessed, the access management function unit restricts the access performed by the host computer 50e. In step S318, the access management function unit performs a monitoring process and an access restricted process, as illustrated in FIG. 8.

In step S318, the access management function unit monitors access to the logical units having “1” to “8” in the LUN fields 76i performed by the host computer 50e. The access management function unit then updates the values in the access count field 77i, the monitoring start time field 78i, the latest access date and time field 79i, and the non-access time period field 80i.

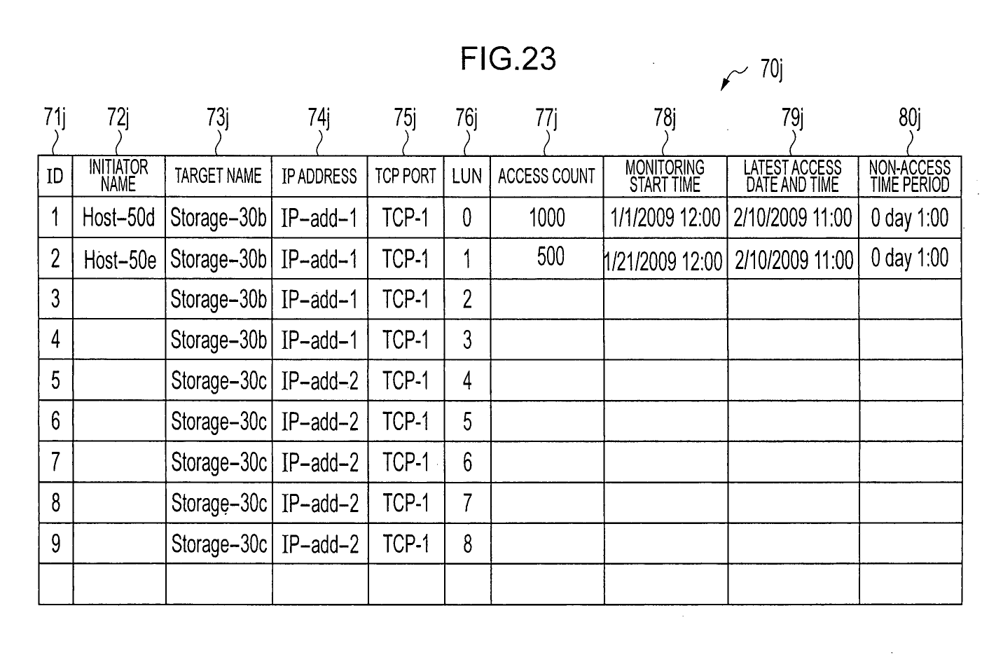

Access management information 70j set after the access restricted process is performed using the number of accesses is described next with reference to FIG. 23. The access management information 70i illustrated in FIG. 22 is changed into the access management information 70j through the access restricted process.

An identification number field 71j, an initiator name field 72j, a target name field 73j, an IP address field 74j, and a TCP port field 75j correspond to the identification number field 71i, the initiator name field 72i, the target name field 73i, the IP address field 74i, and the TCP port field 75i illustrated in FIG. 22, respectively. In addition, a LUN field 76j, an access count field 77j, a monitoring start time field 78j, a latest access date and time field 79j, and a non-access time period field 80j correspond to the LUN field 76i, the access count field 77i, the monitoring start time field 78i, the latest access date and time field 79i, and the non-access time period field 80i illustrated in FIG. 22, respectively.

As illustrated in FIG. 22, the value in the access count field 77i for each of the logical units having “2” and “4” to “8” in the LUN fields 76i is smaller than “10” set in the minimum access count field 94a. Accordingly, through the access restricted process illustrated in FIG. 8 (i.e., the processing performed in steps S144 and S145), the initiator names in the initiator name fields 72j of the records having “2” and “4” to “8” in the LUN fields 76j are deleted, as illustrated in FIG. 23.

As illustrated in FIG. 22, a value in the non-access time period field 80i of the record having “3” in the LUN field 76i is greater than “10 days” contained in the minimum access period field 96a. Accordingly, through the access restricted process using the non-access period of time illustrated in FIG. 10 (i.e., the processing performed in steps S151 and S152), the name in the initiator name field 72j of the record having “3” in the LUN field 76j is deleted, as illustrated in FIG. 23.

The processing performed in steps S319 to S320 is similar to that performed in steps S109 and S110 illustrated in FIG. 5 except that the host computer 50a is replaced with the host computer 50e and the storage computer 30a is replaced with the switch 40b. Accordingly, the descriptions of steps S319 to S320 are not repeated.

An exemplary sequence of data access to the storage computers 30b or 30c performed by the host computer 50f is described next.

The processing performed in steps S321 to S323 is similar to that performed in steps S101 to 5103 illustrated in FIG. 5 except that the host computer 50a is replaced with the host computer 50f and the storage computer 30a is replaced with the switch 40b. Accordingly, the descriptions of steps S321 to S323 are not repeated.

In step S324, the storage area allocation process illustrated in FIG. 6 is performed. In the storage area allocation process (step S324), the access management function unit allocates a storage area to the host computer 50f so that the host computer 50f may access the storage area. The access management function unit records that allocation in the access management information 70j.

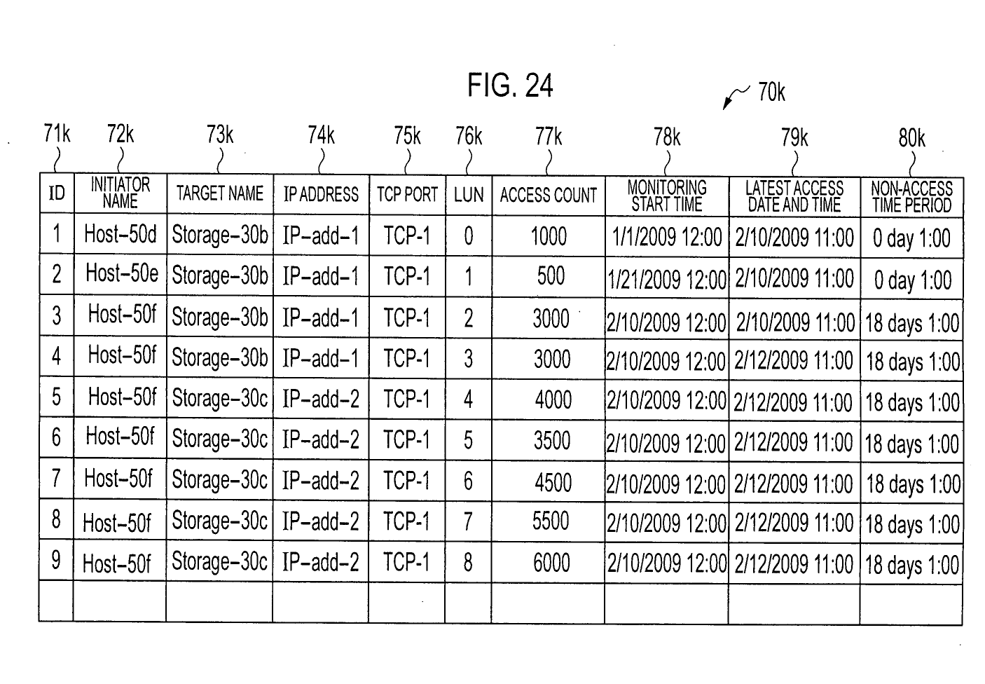

An example of access management information 70k set after the storage area allocation process is performed for the host computer 50f is described next with reference to FIG. 24. The access management information 70j illustrated in FIG. 23 is changed into the access management information 70k through the storage area allocation process.

An identification number field 71k, an initiator name field 72k, a target name field 73k, an IP address field 74k, and a TCP port field 75k correspond to the identification number field 71j, the initiator name field 72j, the target name field 73j, the IP address field 74j, and the TCP port field 75j illustrated in FIG. 23, respectively. In addition, a LUN field 76k, an access count field 77k, a monitoring start time field 78k, a latest access date and time field 79k, and a non-access time period field 80k correspond to the LUN field 76j, the access count field 77j, the monitoring start time field 78j, the latest access date and time field 79j, and the non-access time period field 80j illustrated in FIG. 23, respectively.

As illustrated in FIG. 24, the logical units having “2” to “8” in the LUN fields 76k are allocated to the host computer 50f so that the host computer 50f may access the logical units.

Referring back to FIG. 19B, the switch 40b transmits a message regarding the storage area (step S325). The host computer 50f receives the message and examines the allocated storage area to which access is permitted (step S326). In step S326, the process for examining a storage area to which access is permitted is performed, as illustrated in FIG. 7.

The host computer 50f accesses the storage area to which access is permitted (step S327). The access management function unit examines that the iSCSI name transmitted from the host computer 50f is contained in the target name field 73k and permits the host computer 50f to access the storage computer 30b or 30c. When access is permitted, the access management function unit transfers the iSCSI message received from the host computer 50f or a SCSI command extracted from the iSCSI message to the storage computer 30b or 30c.

If, in step S328, the allocated area is accessed, the access management function unit monitors the storage area accessed by the host computer 50f. However, if a non-allocated area is accessed, the access management function unit restricts the access performed by the host computer 50f. In step S328, the access management function unit performs a monitoring process and an access restricted process, as illustrated in FIG. 8.

In step S328, the access management function unit monitors access to the logical units having “2” to “8” in the LUN fields 76k performed by the host computer 50f. The access management function unit then updates the values in the access count field 77k, the monitoring start time field 78k, the latest access date and time field 79k, and the non-access time period field 80k.

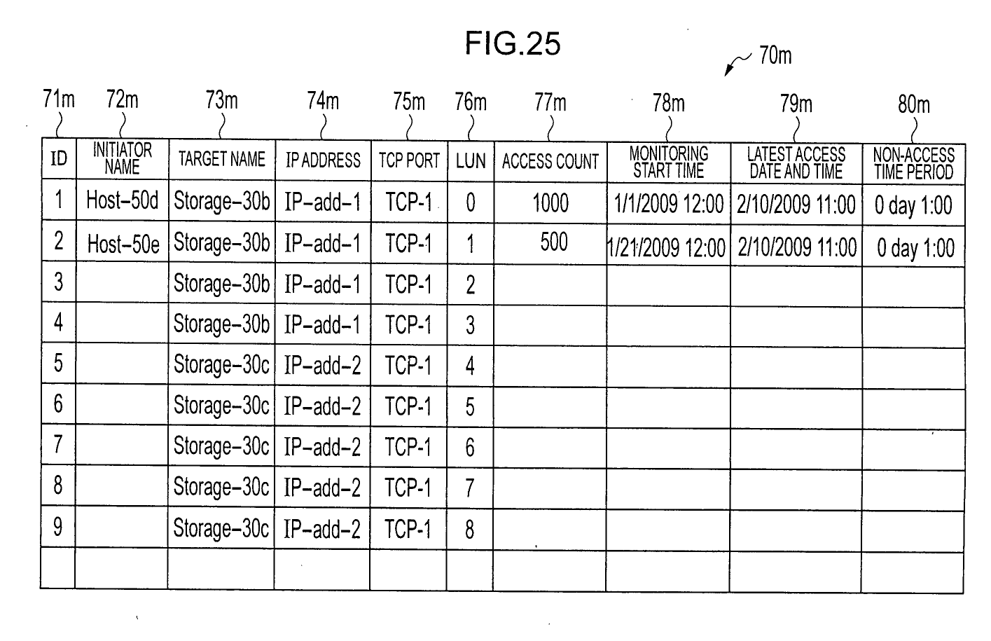

Access management information 70m set after the access restricted process is performed using the number of accesses is described next with reference to FIG. 25. The access management information 70k illustrated in FIG. 24 is changed into the access management information 70m through the access restricted process.

An identification number field 71m, an initiator name field 72m, a target name field 73m, an IP address field 74m, and a TCP port field 75m correspond to the identification number field 71k, the initiator name field 72k, the target name field 73k, the IP address field 74k, and the TCP port field 75k illustrated in FIG. 24, respectively. In addition, a LUN field 76m, an access count field 77m, a monitoring start time field 78m, a latest access date and time field 79m, and a non-access time period field 80m correspond to the LUN field 76k, the access count field 77k, the monitoring start time field 78k, the latest access date and time field 79k, and the non-access time period field 80k illustrated in FIG. 24, respectively.

As illustrated in FIG. 24, each of the values in the non-access time period field 80k for each of the logical units having “2” to “8” in the LUN fields 76k is greater than “10 days” contained in the minimum access period field 96a. Accordingly, through the access restricted process using a non-access period illustrated in FIG. 10 (i.e., the processing performed in steps S151 and S152), the initiator names in the initiator name fields 72m of the records having “2” to “8” in the LUN fields 76m are deleted, as illustrated in FIG. 25.

As described above, if, after access to one of the plurality of storage areas performed by a host computer is permitted, a storage area that has been accessed a number of times less than a predetermined access count within a predetermined period of time by the host computer is found, the access management function unit denies the access to the storage area performed by the host computer. Accordingly, the access management function unit may allocate the storage area that has not been accessed in a predetermined manner by the host computer to a different host computer. As a result, the access management function unit may automatically allocate a storage area to a host computer so that the host computer may access the storage area and use the allocated storage area in an optimal manner. Then, the access control device may automatically allocate an optimal storage area of the storage device accessible to a host computer instead of the restricted allocated storage area.

In addition, if a storage area that has not been accessed by a host computer for a minimum access period of time that is longer than an access count monitoring period of time is found, the access management function unit restricts the access to the storage area performed by the host computer after the access count monitoring period of time has elapsed. Accordingly, the access management function unit may allocate the storage area that the host computer need not access anymore to a different host computer. As a result, the access management function unit may automatically allocate a storage area to a host computer so that the host computer may access the storage area and use the allocated storage area in an optimal manner. Then, the access control device may automatically allocate an optimal storage area of the storage device accessible to a host computer instead of the restricted allocated storage area.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An access control device for controlling access from a host system to a plurality of storage areas in a storage system, the access control device comprising:
a memory for storing access management information for the plurality of storage areas; and
a controller for managing and monitoring access performed by the host system, the controller
monitoring frequency of access by the host system to each of the plurality of storage areas and storing information of the frequency of the access to each of the storage areas in the memory,
detecting at least one of the storage areas in which the frequency of the access is less than a predetermined range, and
restricting the host system from accessing to the detected storage area.

2. The access control device according to claim 1, wherein the access management information includes allocation information regarding at least one of the storage areas allocated to the host system, and the controller deletes the allocation information of the detected storage area to restrict the host system from accessing to the detected storage area.

3. The access control device according to claim 1, wherein the frequency is a number of accesses performed by the host system within a predetermined period of time.

4. The access control device according to claim 1, wherein the controller detects at least one of the storage areas which has not been accessed by the host system for a period of time longer than a predetermined period of time, restricts the host system from accessing to the detected storage area.

5. The access control device according to claim 1, wherein the controller permits the host system to access at least one of non-allocated storage areas temporally, and then restricts the host system from accessing to the detected storage area.

6. A storage system for controlling a storage device to store data from a host system in a plurality of storage areas, the storage system comprising:
a device interface for connecting the storage device; and
an access control device for controlling access from the host system to the plurality of storage areas, the access control device includes:
a memory for storing access management information for the plurality of storage areas; and
an access controller for managing and monitoring access performed by the host system, the controller
monitoring frequency of access by the host system to each of the plurality of storage areas and storing information of the frequency of the access to each of the storage areas in the memory,
detecting at least one of the storage areas in which the frequency of the access is less than a predetermined range, and
restricting the host system from accessing to the detected storage area.

7. The storage system according to claim 6, wherein the access management information includes allocation information regarding at least one of the storage areas allocated to the host system, and the controller deletes the allocation information of the detected storage area to restrict the host system from accessing to the detected storage area.

8. The storage system according to claim 6, wherein the frequency is a number of accesses performed by the host system within a predetermined period of time.

9. The storage system according to claim 6, wherein the access controller detects at least one of the storage areas which has not been accessed by the host system for a period of time longer than a predetermined period of time, and restricts the host system from accessing to the detected storage area.

10. The storage system according to claim 6, wherein the access controller permits the host system to access at least one of non-allocated storage areas temporally, and then restricts the host system from accessing to the detected storage area.

11. An access control method for controlling access from a host system to a plurality of storage areas in a storage system, the access control method comprising:
storing access management information for the plurality of storage areas in a memory;
managing and monitoring access performed by the host system by a controller;
monitoring frequency of access by the host system to each of the plurality of storage areas and storing information of the frequency of the access to each of the storage areas in the memory by the controller;
detecting at least one of the storage areas in which the frequency of the access is less than a predetermined range by the controller; and
restricting the host system from accessing to the detected storage area by the controller.

12. The access control method device according to claim 11, wherein the access management information includes allocation information regarding at least one of the storage areas allocated to the host system, and the controller deletes the allocation information of the detected storage area to restrict the host system from accessing to the detected storage area.

13. The access control method according to claim 11, wherein the frequency is a number of accesses performed by the host system within a predetermined period of time.

14. The access control method according to claim 11, further comprising:
detecting at least one of the storage areas which has not been accessed by the host system for a period of time longer than a predetermined period of time, and restricting the host system from accessing to the detected storage area.

15. The access control method according to claim 11, further comprising:
permitting the host system to access at least one of non-allocated storage areas temporally, and then restricting the host system from accessing to the detected storage area.
